(19) United States
(12) Patent Application Publication
(10) Pub. No.: US 2026/0233176 A1
(43) Pub. Date: Aug. 13, 2026

(54) FLUID HANDLING SYSTEM AND METHOD

(71) Applicant: BioNTech SE, Mainz (DE)

(72) Inventors: Sebastian HÖRNER, Mainz (DE); Heinrich HAAS, Mainz (DE); Alexander BIRKE, Mainz (DE); Benjamin WEBER, Mainz (DE)

(21) Appl. No.: 19/154,210

(22) PCT Filed: Feb. 5, 2024
(86) PCT No.: PCT/EP2024/052811

§ 371 Date: Aug. 6, 2025

(30) Foreign Application Priority Data
Feb. 6, 2023 (WO) PCT/EP2023/052866

(51) Int. Cl. B01F 25/433

(52) U.S. Cl. CPC B01F 25/4337

(57) ABSTRACT

A fluid handling system, comprising a fluid path system, the fluid path system comprising a first fluid path for guiding a first fluid substance towards a mixing region of the fluid path system, a second fluid path for guiding a second fluid substance towards the mixing region, wherein the mixing region is arranged to be in fluid communication with the first fluid path and the second fluid path such that the first fluid substance and the second fluid substance can be mixed in the mixing region to form a fluid substance mixture, wherein the fluid handling system comprises an unguided flow region, wherein the unguided flow region is configured such that the fluid substance mixture can be or is prevented from contacting an inner wall suitable for guiding a flow of the fluid substance mixture along a flow direction of the fluid substance mixture while the fluid substance mixture travels through the unguided flow region, and wherein the unguided flow region extends for a predetermined distance, e.g. extends only for the predetermined distance, downstream of the mixing region.

### BACKGROUND

The present disclosure relates to improvements associated with a fluid handling system and to a method for processing fluids in a fluid handling system.

It is an aim of the present disclosure to provide an improved fluid handling system for processing fluids, e.g. for mixing at least two fluids with each other. The improvements may also relate to the method for processing fluids and a use of the fluid handling system for processing the fluids and a fluid substance mixture obtained from the fluids.

These and/or other aims are achieved by the subject-matter disclosed herein and/or by subject-matter set forth in the appended independent claims as will become apparent from the following description. Advantageous embodiments and refinements, inter alia, are subject to dependent claims.

### SUMMARY

A first aspect of the present disclosure relates to a fluid handling system for processing a first fluid substance and a second fluid substance and for providing or forming a fluid substance mixture. Another aspect of the present disclosure relates to a method for processing fluids, e.g. by mixing a first fluid substance and a second fluid substance, optionally for the fluid substance mixture. The method may be carried out with the fluid handling system of the first aspect; however, other fluid handling systems may also be applied. Another aspect of the present disclosure relates to a use of a fluid handling system for providing a fluid substance mixture, e.g. by mixing a first fluid substance and a second fluid substance and/or employing the method(s) described herein. The fluid handling system may be the fluid handling system of the first aspect.

It is noted that features, which are disclosed herein in connection with the method, also apply to the fluid handling system and/or the use and features, which are disclosed herein for the use or the fluid handling system, also apply for the method. In general, features disclosed in connection with different aspects, examples or embodiments can be combined with one another, even if such a combination is not explicitly described herein. Unless expressly stated otherwise, features disclosed herein above and below apply for all aspects, examples or embodiments of the disclosure, e.g. for the fluid handling system, the method and the use. For example, if method-like features are described they should be understood so as to also relate to the fluid handling system being configured for carrying out or performing these features, such as the fluid handling system being configured to or capable of providing a flow in a mixing region (in a manner equivalent to the one being recited below in connection with the fluid handling system, for example).

In an embodiment, the fluid handling system comprises a fluid path system. The fluid path system comprises a first fluid path for guiding a first fluid substance (also called first fluid herein) towards a mixing region of the fluid path system. The fluid path system further comprises a second fluid path for guiding a second fluid substance (also called second fluid herein) towards the mixing region. The fluid path system may comprise also further fluid paths for guiding further fluid substances towards a mixing region of the fluid path system, e.g. a third fluid path for guiding a third fluid substance, e.g. a gas such as air, towards a mixing region of the fluid path system.

In the following, the fluid handling system will be described for a fluid path system comprising a first fluid path and a second fluid path for a first fluid substance and a second fluid substance, respectively. The system is however not restricted two only two fluid substances and the features relating to the first and/or second fluid path and/or first and/or second fluid substance also hold for further fluid paths and/or fluid substances, e.g. a third fluid path and/or third fluid substance.

The mixing region is arranged to be in fluid communication with the first fluid path and the second fluid path, e.g. simultaneously, such that the first fluid substance and the second fluid substance can be mixed in the mixing region to form a fluid substance mixture. Up to the mixing region, the fluid paths are expediently fluidically separated from one another. The fluid handling system may consist of or comprise the fluid path system. The present disclosure also relates to the fluid path system as such.

The mixing region may be configured to permit a mixing of the first and second fluid substance, e.g. through its shape and/or position with respect to the first and second fluid path. The first and second fluids may enter the mixing region simultaneously.

In an embodiment, the fluid handling system comprises an unguided flow region. The unguided flow region is configured such that the fluid substance mixture can be or is prevented from contacting an inner wall suitable for guiding a flow of the fluid substance mixture along a flow direction of the fluid substance mixture, while the fluid substance mixture travels through the unguided flow region. This may be achieved by various measures. One example is widening the fluid path such that the fluid flow cannot contact an inner wall of the fluid path system. Thus, an inner wall which delimits the fluid path laterally, e.g. circumferentially relative to the flow direction, may be present but the fluid flow (of the fluid substance mixture) does not contact the inner wall while passing through the unguided flow region. Another example is interrupting the fluid path system in the unguided flow region. In this case there is no inner wall present which could contact the fluid flow (of the fluid substance mixture).

In an embodiment, the unguided flow region extends for a predetermined distance, e.g. only for the predetermined distance, downstream of the mixing region. The unguided flow region may be a region of the fluid handling system, e.g. of the fluid path system, where the fluid substance mixture can flow in an unguided manner (e.g. freely). The fluid handling system may be configured such that the fluid substance mixture, when flowing through the unguided flow region is not subject to a directional guiding. The fluid substance mixture flow direction in the unguided flow region may be determined (e.g. determined only) by the direction the substance mixture had when entering the unguided flow region and (e.g. only) gravity when the fluid substance mixture is within the unguided flow region. Thus, in the unguided flow region during operation or use of the fluid handling system, all directional changes (if there are any) of the fluid flow with respect to the fluid path system may be governed by gravity. In the unguided flow region, preferably, there is no contact of the fluid substance mixture and an inner wall of the fluid path system.

In the present disclosure, in other words, any change in direction of the flow of the fluid substance mixture in the unguided flow region and/or at least within the predetermined distance of the unguided flow region may be obtained through gravitational force acting on the fluid substance mixture (e.g. only).

A fluid substance mixture within the meaning of the present disclosure may be a fluid substance, e.g. a liquid, resulting from the mixing of at least two fluid substances, e.g. the first fluid substance and the second fluid substance.

The unguided flow region has proven to be particularly advantageous, e.g. for fluid substance mixtures, which exhibit a transition state or intermediate state, e.g. right after the fluid substances have been mixed for the fluid substance mixture. After the (temporary) intermediate or transition state, the fluid substance mixture may assume a final state. The transition state may be a state in which the final and/or stable physical-chemical characteristics of the fluid substance mixture have not been established yet. In the final state, the fluid substance mixture may have stable, e.g. constant, characteristics. The final state may be a stable state. In the transition state or intermediate state, the fluid substance mixtures may exhibit higher deposition tendencies at an inner wall of the fluid path.

In the transition state of the fluid substance mixture, contact of the fluid substance mixture with any element may increase the possibility of unwanted changes in the physical-chemical characteristics of the fluid substance mixture. Thus, it has proven to be advantageous to provide an unguided flow region extending for a predetermined distance, in which the fluid substance mixture, during its transition period or state does not contact any wall, e.g. any inner wall of the fluid path system. For example, fluid substance mixtures employed during the production of nanoparticle compositions may have an increased tendency to deposit on inner walls of a fluid path system directly after the conditions for nanoparticle formation have been established, e.g. by mixing the first and second fluid substance mixtures. Thus, the predetermined distance is expediently chosen to ensure that the transition state during nanoparticle formation, which has a high affinity for surfaces, e.g. a high tendency to form deposition on surfaces, is completed before contacting an inner wall, e.g. before the unguided flow region ends.

The nanoparticle composition, may be any particle composed of a mixture of at least one lipid and/or at least one polymer, e.g. (ionizable) lipid or liposomes nanoparticles (LNP), (ionizable) lipoplexes (LPX), (ionizable) polyplexes (PPX).

According to at least one embodiment, a fluid guiding element or fluid retaining element of the fluid handling system is positioned downstream of the unguided flow region to receive and/or guide the fluid substance mixture.

The fluid substance mixture may not be in the transition state or intermediate state when received and/or guided by the fluid guiding element or received by the fluid retaining element. Thus, when the fluid substance mixture has passed the unguided flow region, the fluid substance mixture preferably has assumed its stable state.

According to at least one embodiment, the fluid handling system is configured such that the first fluid substance and the second fluid substance can be moved into the mixing region simultaneously. The substances may mix immediately after they have entered the mixing region.

According to at least one embodiment, a diameter (e.g. a maximum, minimum or average diameter) of the first fluid path and/or a diameter (e.g. a maximum, minimum or average diameter) of the second fluid path is greater than or equal to 0.5 mm and/or less than or equal to 5.5 cm. The diameter may be greater than or equal to any one of the following: 0.5 mm, 1 mm, 1.5 mm 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm. Alternatively or additionally, the diameter may be less than or equal to any one of the following: 0.5 mm, 1 mm, 1.5 mm, 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm. The diameter of the first fluid path and/or a diameter of the second fluid path may be between 0.5 mm and 45 mm. The diameter of the first fluid path and/or a diameter of the second fluid path may be greater than or equal to 15.6 mm and/or less than or equal to 12.8 mm. The diameter of the first fluid path and/or a diameter of the second fluid path may be 50.8 mm.

According to at least one embodiment, measured in inch fractions (e.g. SAE (Standard Automotive Engineers)), a diameter (e.g. a maximum, minimum or average diameter) of the first fluid path and/or a diameter (e.g. a maximum, minimum or average diameter) of the second fluid path is greater than or equal to 1/32″ and/or less than or equal to 2″. The diameter may be greater than or equal to any one of the following: 1/32″, 1/16″, ⅛″, ¼″, ¾″, ½″, 1″, 1 1/32″, 1 1/16″, 1⅛″, 1¼″, 1¾″, 1½″, 2″. Alternatively or additionally, the diameter may be less than or equal to any one of the following: 1/32″ 1/16″, ⅛″, ¼″, ¾″, ½″, 1″, 1 1/32″, 1 1/16″, 1⅛″, 1¼″, 1¾″, 1½″, 2″.

The diameter of the first fluid path and the diameter of the second fluid path may be equal or different to each other.

According to at least one embodiment, the fluid flow of the first fluid substance along the first fluid path is drivable or driven by a first flow driver, e.g. a pump, such as a syringe pump, a peristaltic pump, a diaphragm pump and/or a piston pump, or a pressurized vessel.

According to at least one embodiment, the fluid flow of the second fluid substance along the second fluid path is drivable or driven by a second flow driver, e.g. a pump, such as a syringe pump, a peristaltic pump, a diaphragm pump and/or a piston pump, or a pressurized vessel.

According to at least one embodiment, the fluid flow of the fluid substance mixture downstream of the unguided flow region is drivable or driven by a mixture flow driver, e.g. a pump, such as a syringe pump, a peristaltic pump, a diaphragm pump and/or a piston pump, or a pressurized vessel.

According to at least one embodiment, the fluid path system comprises a directing region. The directing region may be arranged between the mixing region and the unguided flow region as seen along the flow direction of the fluid substance mixture. The directing region may be configured to determine an entry flow direction of the fluid substance mixture with which the fluid substance mixture enters the unguided flow region. In this way it may be ensured that the flow of the fluid substance mixture is directed into the unguided flow region so as to avoid a contact of the fluid substance mixture with a wall, e.g. an inner wall, of the unguided flow region.

According to at least one embodiment, the directing region has a length of less than or equal to one of the following values: 10 cm, 9 cm, 8 cm, 7 cm, 6 cm, 5 cm, 4 cm, 3.5 cm, 3 cm, 2.5 cm, 2 cm, 1.5 cm, 1 cm, 0.5 cm, 0.4 cm, 0.3 cm, 0.2 cm, 0.1 cm.

According to at least one embodiment, the directing region has a length of greater than or equal to one of the following values: 0.05 cm, 0.1 cm, 0.2 cm, 0.5 cm, 1 cm, 1.5 cm, 2 cm, 2.5 cm, 3 cm, 3.5 cm, 4 cm, 5 cm, 6 cm, 7 cm, 8 cm, 9 cm, 10 cm.

The directing region may have a length of between 0.05 cm and 10 cm. In particular the directing region may have a length of 2.2 cm.

According to at least one embodiment, the entry flow direction is parallel to a main axis of the unguided flow region.

According to at least one embodiment, the entry flow direction is angled with respect to a main axis of the unguided flow region.

In both cases, e.g. in the parallel or in the angled case, the directing region is arranged such that the fluid substance mixture flowing out of the directing region enters the unguided flow region so as to be prevented from contacting an inner wall suitable for guiding the flow in the unguided flow region.

According to at least one embodiment, a fluid path of the fluid path system guiding the fluid substance mixture widens as seen along the flow direction from the mixing region towards the unguided flow region along the flow direction away from the mixing region, e.g. at the end of the directing region.

According to at least one embodiment, e.g. for the predetermined distance, the fluid handling system, e.g. due to an interruption of the fluid path system in the unguided flow region and/or due to a mixture fluid path of the fluid path system being configured with an appropriate width in the unguided flow region, has a free fall region or free flow region. The free flow region may allow the fluid substance mixture to travel within the fluid handling system without contacting the inner wall of the fluid handling system, e.g. the inner wall which is closest to the fluid substance mixture.

According to at least one embodiment, the fluid path system defines a first flow direction for a flow of the first fluid substance from the first fluid path into the mixing region through a first inlet and the fluid path system defines a second flow direction for a flow of the second fluid substance from the second fluid path into the mixing region through a second inlet. The first flow direction and the second flow direction may define an angle. The angle may be in a range between 45° and 315°, e.g. in a range between 60° and 300°, e.g. between 120° and 270° or about 180°.

According to at least one embodiment the mixing region may comprise more than one, e.g. two, first inlets for the first fluid path for the first fluid substance and/or more than one, e.g. two, second inlets for the second fluid path for the second fluid substance mixture. As such the mixing region, may for example have three inlets through which the first and the second fluid substance enter the mixing region, e.g. two first inlets for the first fluid substance and one second inlet for the second fluid substance. The first fluid substance and the second fluid substance can be moved into the mixing region simultaneously in embodiments in which the mixing region comprises more than one first inlets and/or more than one second inlets for the first fluid substance and the second fluid substance, respectively.

According to at least one embodiment, the mixing region may comprise one or more further inlets for a further fluid path for a further fluid substance, e.g. one or more third inlets for a third fluid path for a third fluid substance, e.g. for air.

All characterizations of the first and/or second fluid paths and first and/or second fluid substances in correlation with the embodiments in which the mixing region comprises one first inlet for the first fluid substance and one second inlet for the second fluid substances described herein may also hold for the embodiments where the mixing region has one or more first inlets and/or one or more second inlets and/or one or more further inlets, e.g. third inlets.

According to at least one embodiment, the mixing region has an outlet for the fluid substance mixture and/or the unguided flow region comprises an entry region.

According to at least one embodiment, an inner diameter of the outlet or the entry region is greater than or equal to 0.5 mm and less than or equal to 6 cm, e.g. between 1 mm and 5.2 cm.

The inner diameter of the outlet or the entry region may be greater than or equal to 0.5 mm, 5 mm, 10 mm, 15 mm, 20 mm, 25 mm, 30 mm, 35 mm, 40 mm, 45 mm, 50 mm, 55 mm, 60 mm. The inner diameter of the outlet or the entry region may be less than or equal to 60 mm, 55 mm, 50 mm, 45 mm, 40 mm, 35 mm, 30 mm, 25 mm, 20 mm, 15 mm, 10 mm, 5 mm, 0.5 mm. For example, less than or equal to 52 mm.

The inner diameter of the outlet or the entry region may be for example between 1 mm and 60 mm, for example between 30 mm and 52 mm.

According to at least one embodiment, the entry region of the unguided flow region adjoins or coincides with the outlet of the directing region.

If the fluid handling system does not comprise a directing region, the entry region of the unguided flow region may adjoin or coincide with the outlet of the mixing region. In such a case, the outlet of the mixing region may be arranged such that the fluid substance mixture flowing out of the outlet of the mixing region enters the unguided flow region in such a way as to be prevented from contacting an inner wall suitable for guiding the flow in the unguided flow region.

According to at least one embodiment, the predetermined distance is greater than or equal to any one of the following values: 5 cm, 6 cm, 7 cm, 8 cm, 9 cm, 10 cm, 11 cm, 12 cm, 13 cm, 20 cm, 35 cm, 50 cm, 80 cm, 100 cm, 200 cm. Alternatively or additionally, the predetermined distance is less than or equal to any one of the following values: 600 cm, 565 cm, 550 cm, 500 cm, 450 cm, 400 cm, 300 cm, 200 cm, 165 cm, 68 cm, 35 cm, 30 cm, 25 cm, 20 cm, 15 cm, 13 cm. Thus, the predetermined distance may be between 5 cm and 565 cm or 600 cm, e.g. between 5 cm and 13 cm.

According to at least one embodiment, the predetermined distance is chosen such that the fluid substance mixture, e.g. at a predetermined flow rate of the substance mixture, has the majority or the entirety of its intermediate or transition state within the unguided flow region.

According to at least one embodiment, the predetermined distance is chosen such that the fluid substance mixture travels at least for a predetermined period of time in the unguided flow region. The predetermined period of time may be a time characteristic for the time required for the fluid substance mixture reaching the stable or final state. For example, the predetermined period of time may be greater than the time needed for reaching the stable or final state or greater than 80% of the time which requires the fluid substance mixture to assume its stable state.

According to at least one embodiment, the predetermined period of time is less than or equal to one of the following: 1 s, 950 ms, 900 ms, 850 ms, 800 ms, 750 ms, 700 ms, 650 ms, 600 ms, 550 ms, 500 ms, 450 ms, 400 ms.

According to at least one embodiment, the predetermined period of time is greater than or equal to one of the following: 1 ms, 5 ms, 10 ms, 20 ms, 25 ms, 50 ms, 100 ms, 150 ms, 200 ms, 300 ms.

According to at least one embodiment, the fluid handling system is configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region, in the directing region, at the first inlet, at the second inlet and/or at the outlet (e.g. the outlet of the mixing region), which is characterized by a calculated Reynolds number (Re) of greater than or equal to one of the following values: 500, 1000, 1100, 1200, 1300, 1400, 1500, 1700, 1800, 1900, 2000.

According to at least one embodiment, the fluid handling system is configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region, in the directing region, at the first inlet, at the second inlet and/or at the outlet (e.g. the outlet of the mixing region), which is characterized by a calculated Reynolds number (Re) of less than or equal to one of the following values: 10000, 7500, 5000, 4000, 3000, 2900, 2800, 2700, 2600, 2500.

According to at least one embodiment, the fluid handling system is capable of handling or providing a fluid flow, the fluid flow, e.g. in the mixing region, in the directing region, at the first inlet, at the second inlet and/or at the outlet, having a Reynolds number (Re) of between 500 and 10000, e.g. between 500 and 3000, such as between 1700 and 2500.

Reynolds numbers are used to classify a fluid flow, e.g. a liquid flow. The Reynolds number R of a fluid flow can be calculated by using the following formula:

$$R = V ⋆ D / Vis\_kin ,$$

where V is the velocity of the fluid flow in m/s (meters per second), D is a characteristic distance (e.g. the diameter of the flow path guiding the fluid flow, e.g. the inner diameter of a conduit) in m (meter) and Vis_kin is the kinematic viscosity in m²/s. The kinematic viscosity results from the (dynamic) viscosity (Vis_dyn) of the fluid in Pascal seconds, Pas, divided by the density D_L of the fluid, e.g. in kg/m³. The velocity V can be derived from the flow rate (e.g. specified in ml/min, i.e. millilitres per minute) by dividing the flow rate by the cross-sectional area of the flow path guiding the fluid flow. The cross section is taken perpendicular to the flow direction. For a circular cross-section the cross-sectional area is (ID/2)²*π, with ID being the inner diameter of the flow path, e.g. of an outlet, conduit or tubing.

For determining the Reynolds number of the fluid flow away from the mixing region and/or at the outlet of the mixing region or of the mixing component, characteristic values of the first and second fluids can be used (if applicable weighted with a factor determining the contribution of the flow rate of the first and second fluid into the mixing chamber to the total flow rate of the first and second fluids). Thus, the respective Reynolds number for the fluid substance mixture flow discussed herein may relate to Reynolds numbers based on values for the relevant quantities which are calculated as set forth below or based on values for the relevant quantities which have been measured.

For the fluid substance mixture, i.e. after the first fluid substance and the second fluid substance have been mixed, the Reynolds number may be calculated by using:

$$V = ( F\_ 1 + F\_ 2 ) / ( {( D / 2 )}^{2} ⋆ π ) ,$$

with
D being the inner diameter of the flow path at the relevant location, e.g. at the outlet of the mixing region,
F_1 being the flow rate of the first fluid substance into the mixing region, and
F_2 being the flow rate of the second fluid substance into the mixing region (the sum of F_1 and F_2 being the flow rate of the fluid substance mixture at the outlet of the mixing region).

$$Vis\_dyn = F\_ 1 / ( F\_ 1 + F\_ 2 ) ⋆ Vis\_ 1 + F\_ 2 / ( F\_ 1 + F\_ 2 ) ⋆ Vis\_ 2 ,$$

with
Vis_1 being the (dynamic) viscosity of the first fluid substance,
Vis_2 being the dynamic viscosity of the second fluid substance.

$$D\_L = F\_ 1 / ( F\_ 1 + F\_ 2 ) ⋆ D\_ 1 + F\_ 2 / ( F\_ 1 + F\_ 2 ) ⋆ D\_ 2 ,$$

with
D_1 being the density of the first fluid substance
D_2 being the density of the second fluid substance

$$Vis\_kin = Vi\_dyn / D\_L$$

The Reynolds number then results from:

$$R = V ⋆ D / Vis\_kin$$

Reynolds numbers are dimensionless quantities. The Reynolds number can be used to qualify a fluid flow without having to specify dimensions of the conduit or other values which are characteristic for the flow like the flow rate, viscosity, density, etc.

According to at least one embodiment, the first fluid substance and the second fluid substance are chosen such that the fluid substance mixture resulting from mixing the first fluid substance and the second fluid substance has an intermediate state, e.g. during and/or directly after mixing of the first fluid substance and the second fluid substance.

According to at least one embodiment, the intermediate state is a temporary state, e.g. a state existing only for less than the predetermined period of time.

According to at least one embodiment, the fluid substance mixture, after the intermediate state, assumes a stable state.

According to at least one embodiment, the fluid substance mixture, in the intermediate state, has a greater tendency to form a deposit on a wall, e.g. an inner wall delimiting a fluid path, than in the stable state.

The intermediate state may also be called colloquially “sticky phase”, as it is a state of the fluid substance mixture in which it tends to form deposits (i.e. “stick”) on the walls and in which it may cause clogging of any tubing through which it is passing in its intermediate state. With increasing processed volume, the intermediate state may cause an occlusion of the flow path, e.g. formed by a tubing, through which it passes to be fully clogged, thereby unintentionally blocking and damaging the production process of the fluid substance mixture. This will limit the volume which can be processed with a given fluid path system. Avoiding or reducing clogging such as by providing the unguided flow region is therefore advantageous.

Furthermore, during the process a portion of the deposition may shear off. This causes a modification in the size-distribution of the nanoparticles over time (e.g. uneven distribution of particle size). This being clearly detrimental for the end product (e.g. fluid substance mixture).

It is advantageous to provide the fluid handling system with an unguided flow region in which the fluid substance mixture, during its intermediate state, e.g. the sticky phase, (or at least during a period of its intermediate state, e.g. the majority of the duration of the intermediate state) does not contact any wall, e.g. any inner wall, thereby minimising the probability of deposit formation and clogging. This may lead to a higher output during the processing, to a more homogeneous end product with evenly distributed particle sizes, as well as to less failures in or during the production process.

This may be achieved, for instance, by means of the unguided flow region, e.g. the free fall region, in which the fluid substance mixture is prevented from contacting any wall (e.g. the inner wall of the unguided flow region).

According to at least one embodiment, the fluid handling system is configured such that the fluid substance mixture, in its intermediate state or at least during a period of its intermediate state, flows in the unguided flow region.

According to at least one embodiment, the fluid handling system is configured and/or operable such that the fluid substance mixture, in its intermediate state, only flows in the mixing region and/or the unguided flow region and/or, optionally, the directing region.

According to at least one embodiment, the first fluid substance and the second fluid substance are chosen to establish a fluid substance mixture comprising colloids, e.g. having an average particle size greater than or equal to 10 nm and/or less than or equal to 1000 nm, for instance of between 200 and 500 nm, such as around 400 nm. According to at least one embodiment the average particle size may be greater or equal than 250 nm and/or less or equal to 750 nm. According to at least one embodiment the average particle size may be greater or equal than 60 nm and/or less or equal to 140 nm. According to at least one embodiment the average particle size may be greater or equal than 50 nm and/or less or equal to 150 nm. According to at least one embodiment the average particle size may be greater or equal than 10 nm and/or less or equal to 300 nm.

According to at least one embodiment the first fluid substance and the second fluid substance are chosen to establish a fluid substance mixture comprising colloids, e.g. having an average particle size greater than or equal to 10 nm, 20 nm, 50 nm, 100 nm, 250 nm, 300 mm, 350 nm, 400 nm, 450 nm, 500 nm, 600 nm, 650 nm, 700 nm. Additionally or alternatively, the first fluid substance and the second fluid substance are chosen to establish a fluid substance mixture comprising colloids, e.g. having an average particle size of less than or equal to 750 nm, 700 nm, 650 nm, 600 nm, 550 nm, 500 nm, 450 nm, 400 nm, 350 nm, 300 nm, 250 nm, 200 nm, 150 nm, 100 nm, 50 nm, 20 nm.

The particle size may depend on the starting materials used.

According to at least one embodiment, the fluid handling system may be operated with a process volume of greater than or equal to 50 mL, such as greater than or equal to 100 mL, 200 mL, 500 mL, 700 mL, or even greater than or equal to 900 mL or 1 L, or even greater or equal to 10 L or 20 L, for example 12 L or 12.2 L, or even greater or equal to 50 L or 100 L, or even greater or equal to 500 L or 1000 L.

According to at least one embodiment, the fluid handling system may be operated with a process volume of less than or equal to 1000 L, 500 L, 100 L, 50 L, 20 L, such as less than or equal to 500 L, 400 L, 300 L, 12 L, 10 L, 2 L, 1 L, 700 mL, 500 mL, 200 mL, or even less than or equal to 100 mL or 50 mL.

The fluid handling system may be operated with a process volume of between 50 mL to 20 L, for example between 2 L and 20 L, for example 12.2 L.

The fluid handling system is however not limited to any of these process volumes and may comprise, for example, a process volume higher than 1000 L.

According to at least one embodiment, the process is continuous, thereby having, theoretically unlimited process volumes, e.g. a process volume than increases as long as the system is being operated.

According to at least one embodiment, the first fluid substance comprises an ionic and/or ionizable substance.

According to at least one embodiment, the second fluid substance comprises an ionic and/or ionizable substance.

According to at least one embodiment, the ionic substance is a cationic or an anionic substance or a cationic and anionic substance, e.g. a zwitterionic substance.

According to at least one embodiment, the ionizable substance is a cationic ionizable substance or an anionic ionizable substance or a cationic and anionic ionizable substance, e.g. a zwitterionic ionizable substance.

According to at least one embodiment, the ionic substance of the first fluid substance is an anionic substance and the ionic substance of the second fluid substance is a cationic substance.

According to at least one embodiment, the first fluid substance comprises a substance of polymeric nature, e.g. an ionic substance of polymeric nature.

According to at least one embodiment, the first fluid substance comprises a nucleic acid, a peptide or a protein.

According to at least one embodiment, the first fluid substance comprises RNA such as mRNA, wherein, optionally, the first fluid substance is an RNA solution.

According to at least one embodiment, the second fluid substance is a colloidal suspension, e.g. an ionic colloidal suspension, such as a cationic colloidal suspension.

According to at least one embodiment, the second fluid substance comprises a hydrophilic and/or lipophilic substance, e.g. an amphiphilic substance.

According to at least one embodiment, the second fluid substance comprises at least one lipid, e.g. a mixture of lipids.

According to at least one embodiment, the second fluid substance comprises liposomes.

According to at least one embodiment, the second fluid substance comprises a cationic polymer.

For instance, but without limitation, the second fluid substance may comprise at least one lipid selected from the group consisting of
(i) an ionizable lipid, preferably an ionizable cationic lipid, such as an ionizable cationic amino lipid, for instance ALC-0315 ((4-hydroxybutyl) azanediyl)bis(hexane-6,1-diyl)bis(2-hexyldecanoate)), or SM-102 (heptadecan-9-yl 8-((2-hydroxyethyl) (6-oxo-6-(undecyloxy) hexyl)amino) octanoate), or DOPE (1,2-dioleoyl-sn-3-phosphoethanolamine), or DOTMA (N-(2,3-dioleyloxy)propyl)N,N,N-trimethylammonium chloride) or DOSPA (N-(1-(2,3dioleyloxy)propyl)-N-(2-(sperminecarboxamido)ethyl)-N,N-dimethylammonium trifluoroacetate);
(ii) a non-cationic helper lipid or phospholipid, such as a neutral lipid and for instance DSPC (1,2-distearoyl-i77-glycero-3-phosphocholine) or an analogue or a substitute thereof;
(iii) a sterol or other structural lipid, for instance cholesterol; and
(iv) a PEG lipid, for instance 1,2-dimyristoyl-snglycerol methoxypolyethylene glycol (PEG-DMG). Other lipids may also be suitable to be comprised by the second fluid. Further alternatives to PEG Lipids are: Polysarcosine, polyoxazoline, non-charged lipid e.g., pSar or pMeOx. The PEG Lipids alternatives are however not limited to the ones mentioned.

According to at least one embodiment, the first fluid substance and the second fluid substance both are colloidal suspensions, e.g. ionic colloidal suspensions.

According to at least one embodiment, the first fluid substance is or comprises a polymeric amphiphilic substance or a polymeric lipophilic substance or a polymeric hydrophilic substance and

wherein the second fluid substance comprises an amphiphilic or a polymeric amphiphilic substance or a polymeric lipophilic substance or a polymeric hydrophilic substance.

According to at least one embodiment, the first fluid substance and/or the second fluid substance is buffered. According to at least one embodiment, the first fluid substance and/or the second fluid substance is not buffered.

According to at least one embodiment, one of the first fluid substance and second fluid substance or the fluid substance mixture is a pharmaceutical substance, e.g. a biopharmaceutical substance.

According to at least one embodiment, at least one of or both of the first fluid substance and the second fluid substance is an aqueous composition, e.g. an aqueous solution or an aqueous dispersion, or both of the first fluid substance and the second fluid substance are aqueous compositions, e.g. aqueous solutions or aqueous dispersions.

According to at least one embodiment, at least one of or both of the first fluid substance and the second fluid substance is a solution.

According to at least one embodiment, at least one of or both of the first fluid substance and the second fluid substance is a dispersion.

According to at least one embodiment, the first fluid substance is an aqueous composition, e.g. an aqueous solution or an aqueous dispersion, and the second fluid substance is an organic composition.

According to at least one embodiment, the organic composition is an organic solution or dispersion.

An organic composition may be defined as a composition comprising e.g. more than 1%, 10%, 25%, 50% of an organic solvent.

According to at least one embodiment, one of or both of the first fluid substance and the second fluid substance are medical fluid substances.

According to at least one embodiment, the fluid substance mixture is a colloidal suspension and/or comprises particles, e.g. nanoparticles. The particles may be formed from one or more constituents of the first fluid substance and from one or more constituents of the second fluid substance. The particles may be any nanoparticle, e.g. polymer nanoparticles or particles comprising a lipid and a polymer, e.g. lipid or liposome nanoparticles (LNP), lipoplexes (LPX), polyplexes (PPX). The nanoparticle composition may comprise a nucleic acid, e.g. RNA (Ribonucleic acid) such as mRNA (messenger ribonucleic acid), or DNA (Deoxyribonucleic acid).

According to at least one embodiment, the nanoparticles may have a size (e.g. a maximum, minimum or average diameter) of greater than or equal to 20 nm, 50 nm, 100 nm, 250 nm, 300 mm, 350 nm, 400 nm, 450 nm, 500 nm, 600 nm, 650 nm, 700 nm. According to at last one embodiment, nanoparticles may have a size of less than or equal to 750 nm, 700 nm, 650 nm, 600 nm, 550 nm, 500 nm, 450 nm, 400 nm, 350 nm, 300 nm, 250 nm, 200 nm, 150 nm, 100 nm, 50 nm. The nanoparticle may have a size between 20 nm and 1000 nm, for example between 250 nm and 750 nm.

According to at least one embodiment, the first fluid path is fluidly connected to or fluidly connectable to a first reservoir comprising the first fluid substance such that the first fluid substance can be driven from the first reservoir towards the mixing region through the first fluid path, and/or the second fluid path is fluidly connected to or fluidly connectable to a second reservoir comprising the second fluid substance such that the second fluid substance can be driven from the second reservoir towards the mixing region through the second fluid path.

According to at least one embodiment, the fluid path system is a closed system. In this context, the term “closed” refers to a system which is sealed off from the environment between one or more system inlets and one or more system outlets. This guarantees sterility of the system. In closed systems, the fluid path system at any location within the fluid path system has an inner wall delimiting it from the exterior.

According to at least one embodiment, the fluid path system may be pressure equilibrated through a sterile filter. In other words, sterile inlets and/or outlets, e.g. through sterile filters for pressure equilibration, are allowed.

According to at least one embodiment, the fluid path system is an uninterrupted system. “Uninterrupted”, in the present context, may be understood such that each element through which the first fluid substance, the second fluid substance and the fluid substance mixture passes are physically connected to each other without any interruption.

According to at least one embodiment, the fluid path system is an interrupted system. The unguided flow region, for example, may not be physically connected to the directing region. However, uninterrupted and/or closed systems are preferred e.g. to maintain sterility within the fluid path system.

According to at least one embodiment, the fluid handling system comprises a reservoir region for collecting the fluid substance mixture, the reservoir region being arranged downstream of the unguided flow region as seen along the flow direction of the fluid substance mixture in the fluid handling system.

According to at least one embodiment, the fluid substance mixture, in the reservoir region, forms a surface, which delimits the reservoir region, e.g. on the side facing towards the unguided flow region as seen in the direction opposite to the flow direction of the fluid substance mixture towards the reservoir region.

According to at least one embodiment, the fluid handling system is configured such that the fluid substance mixture, after having travelled through the unguided flow region, enters the reservoir region via the surface, e.g. in the form of a fluid jet or fluid drops impinging on the surface.

According to at least one embodiment, the fluid handling system comprises a reservoir region outlet which is in fluid communication with the reservoir region and which is provided to remove content, e.g. the fluid substance mixture, from the reservoir region.

According to at least one embodiment, the fluid substance mixture in the reservoir region contacts an inner wall delimiting the fluid handling system laterally.

The fluid substance mixture in the reservoir region may no longer exhibit its transition state, e.g. its intermediate state, such that a contact of the fluid substance mixture with the inner wall of the reservoir region may not (or at least not substantially) alter the physical-chemical characteristic of the fluid substance mixture or its constituents (such as particles, e.g. nanoparticles, e.g. RNA such as mRNA, lipid or liposome nanoparticles (LNP), Lipoplexes (LPX), Polyplexes (PPX).

According to at least one embodiment, the fluid path system comprises the reservoir region.

According to at least one embodiment, the reservoir region is arranged within a container.

According to at least one embodiment, the reservoir region or the container has a volume greater than the mixing region. According to at least one embodiment, the reservoir region or the container has a volume smaller than the mixing region.

According to at least one embodiment, the container or the reservoir region has a filling capacity of greater than or equal to: 0.5 L, 1 L, 2 L, 3 L, 4 L, 5 L, 6 L, 7 L, 8 L, 9 L, 10 L, 15 L, 20 L, 25 L, 30 L, 35 L, 40 L, 45 L, 50 L, 100 L, 200 L, 300 L, 400 L, 500 L, 600 L, 700 L, 800 L, 900 L, 1000 L.

According to at least one embodiment, the container or the reservoir region has a filling capacity of less than or equal to: 1000 L, 900 L, 800 L, 700 L, 600 L, 500 L, 400 L, 300 L, 200 L, 150 L, 100 L, 50 L, 45 L, 40 L, 35 L, 30 L, 25 L, 20 L, 15 L, 10 L, 5 L. The container or the reservoir region may have a filling capacity of between 0.5 L and 1000 L, for example of between 10 L and 500 L, for example 50 L.

According to at least one embodiment, the container, e.g. a bag, is collapsible and/or has flexible walls delimiting its interior or the container, e.g. a flask, is non-collapsible and/or has rigid walls delimiting its interior.

According to at least one embodiment, at least a portion of the unguided flow region or the entire unguided flow region is within the container.

According to at least one embodiment, the fluid handling system, e.g. the container, comprises a port for adding a further substance to the fluid substance mixture, e.g. downstream of the unguided flow region and/or in the container.

According to at least one embodiment, the fluid handling system is configured such that the fluid substance mixture, downstream of the unguided flow region, is guided away from the unguided flow region towards an exit of the fluid handling system or fluid path system e.g. to enable a continuous withdrawal of fluid substance mixture from the fluid handling system via the exit.

The guiding away of the fluid substance mixture from the fluid handling system may occur directly downstream of the unguided flow region, so that the fluid substance mixture exiting the unguided flow region is guided away. The guiding away of the fluid substance mixture from the fluid handling system may however also occur downstream of the reservoir region. From the reservoir region the fluid substance mixture may be guided away towards an exit of the fluid handling system or fluid path system.

According to at least one embodiment, the fluid handling system comprises a mixture flow driver. The mixture flow driver may be a pump, e.g. one of the ones mentioned above, or may be of another type mentioned previously for the first or second flow driver. The mixture flow driver may be configured to displace fluid substance mixture away from the reservoir region, e.g. towards an outlet of the fluid path system and/or the fluid handling system. Due to the unguided flow region fluid driver which drive the fluids into the unguided flow region may not be suitable to drive the fluid substance mixture away from the reservoir region. Hence, the mixture flow drive may improve the fluid handling system.

According to at least one embodiment, the fluid path system, in the unguided flow region, comprises an increased diameter of a mixture fluid path of the fluid path system such that an unguided flow of the fluid substance mixture in the unguided flow region is enabled.

According to at least one embodiment, the diameter of the mixture fluid path varies in the unguided flow region. It may vary to facilitate the prevention of contact of the fluid substance mixture with the walls, e.g. inner walls of the unguided flow region.

According to at least one embodiment, a diameter of the mixture fluid path increases in a direction away from the mixing region in the unguided flow region, e.g. at least in a section of the mixture fluid path and/or continuously (e.g. up to the reservoir region).

According to at least one embodiment, a diameter of the mixture fluid path decreases in a direction away from the mixing region in the unguided flow region, e.g. at least in a section of the mixture fluid path and/or continuously.

According to at least one embodiment, the fluid handling system comprises at least one agitator to agitate fluid substances. The fluid substances, may for example be the fluid substance mixture in the mixing region.

According to at least one embodiment, at least one agitator is arranged to agitate the fluid substance mixture, e.g. in the reservoir region.

According to at least one embodiment, at least one agitator is arranged in the content to be agitated.

According to at least one embodiment, at least one agitator is a magnetic agitator, e.g. a magnetic stirring bar.

According to at least one embodiment, the mixing region has a first inlet for the first fluid substance and a second inlet for the second fluid substance. The first inlet and the second inlet may adjoin or coincide with the outlet of the first fluid path and the second fluid path, respectively.

According to at least one embodiment, the mixing region is formed by and/or in a mixing component, which is connected to a first tubing defining the first fluid path and/or a second tubing defining the second fluid path.

According to at least one embodiment, the mixing component has an outlet directed towards the unguided flow region, optionally directed towards the directing region or being part of the directing region.

According to at least one embodiment, the mixing component is a T-shaped component, a Y-shaped component or a X-shaped component (e.g. a component comprising two first inlets or two second inlets for the first fluid substance or the second fluid substance, respectively, e.g. a component comprising a first inlet for the first fluid substance and two second inlets for the second fluid substance or comprising two first inlets for the first fluid substance and one second inlet for the second fluid substance). The X-shaped component may also comprise a first inlet for the first fluid substance, a second inlet for the second fluid substance and a third inlet for the third fluid substance. The mixing component may also have a psi-geometry.

According to at least one embodiment, the mixing region is provided by a section of a continuous tubing structure, the tubing structure having further sections providing the first fluid path and the second fluid path. The first and second fluid paths may be fluidically separated from one another up to the mixing region.

According to at least one embodiment, structural elements which guide the first fluid, the second fluid, and/or the fluid substance mixture may be made of or comprise plastic or non-plastic materials. For example, a tubing structure for the first fluid path, the second fluid path and/or the mixing region may be made of or comprises plastic, e.g. medical grade plastic and/or polypropylene or polyvinylidene fluoride (PVDF), or non-plastic materials e.g. medical grade materials such as stainless steel. Also, further elements of the fluid handling system may be made of or comprise these material (e.g. the unguided flow region or the directing region or the mixing component).

According to at least one embodiment, the fluid handling system is configured so as to provide a turbulent mixing of the first fluid substance and the second fluid substance in the mixing region.

In a further aspect, the present disclosure relates to a method for processing fluids, comprising: guiding a first fluid substance and a second fluid substance within a fluid path system, e.g. the one described above, to a mixing region to form a fluid substance mixture, and preventing contact between the fluid substance mixture and a wall (e.g. the inner wall) of the fluid path system for a predetermined period of time, in an unguided flow region along the flow direction of the fluid substance mixture downstream of the mixing region.

According to at least one embodiment, the method comprises guiding a third fluid substance within the fluid path system, to the mixing region to form the fluid substance mixture.

According to at least one embodiment, the predetermined period of time is less than or equal to one of the following: 1 s, 950 ms, 900 ms, 850 ms, 800 ms, 750 ms, 700 ms, 650 ms, 600 ms, 550 ms, 500 ms, 450 ms, 400 ms.

According to at least one embodiment, the predetermined period of time is greater than or equal to one of the following: 1 ms, 5 ms, 10 ms, 20 ms, 25 ms, 50 ms, 100 ms, 150 ms, 200 ms, 300 ms.

According to at least one embodiment, the first fluid substance and the second fluid substance are chosen such that the fluid substance mixture resulting from mixing the first fluid substance and the second fluid substance has an intermediate state, e.g. during and/or directly after mixing of the first fluid substance and the second fluid substance.

According to at least one embodiment, the intermediate state is a temporary state, e.g. a state existing only for less than a period of time. The period of time may substantially correspond to the predetermined period of time in which the fluid substance mixture is prevented from contacting a wall (e.g. an inner wall) of the unguided flow region or may be shorter than this predetermined period of time.

According to at least one embodiment, guiding the first fluid substance to a mixing region comprises guiding the first fluid substance through a first fluid path of the fluid path system.

According to at least one embodiment, guiding the second fluid substance to a mixing region comprises guiding the second fluid substance through a second fluid path of the fluid path system.

According to at least one embodiment, guiding the third fluid substance to a mixing region comprises guiding the third fluid substance through a third fluid path of the fluid path system.

According to at least one embodiment, the method further comprises the step of guiding the fluid substance mixture through a directing region positioned downstream of the mixing region to direct the fluid substance mixture towards the unguided flow region.

According to at least one embodiment, the method further comprises the step of guiding the fluid substance mixture within a fluid guiding element of the fluid path system positioned downstream of the unguided flow region and/or receiving the fluid substance mixture in a fluid retaining element (e.g. the reservoir region) of the fluid path system positioned downstream of the unguided flow region.

According to at least one embodiment, the method further comprises the step of guiding the first fluid and the second fluid simultaneously into the mixing region.

According to at least one embodiment, the method further comprises the step of driving the fluid flow of the first fluid with a first flow driver, e.g. a pump, such as a syringe pump, a peristaltic pump, a pressurized vessel, and/or a piston pump.

According to at least one embodiment, the method further comprises the step of driving the fluid flow of the second fluid with a second flow driver, e.g. a pump, such as a syringe pump, a peristaltic pump, a pressurized vessel, and/or a piston pump.

According to at least one embodiment, the method further comprises the step of driving the flow of the fluid substance mixture downstream or away from the unguided flow region with a mixture flow driver, e.g. a pump, such as a syringe pump, a peristaltic pump, a diaphragm pump and/or a piston pump, or a pressurized vessel. The fluid substance mixture, when passing through the unguided flow region or having passed that region, without contacting a wall (e.g. an inner wall) may no longer be influenced by the first and second flow drivers. The mixture flow driver may allow a displacement of the fluid substance mixture when the fluid substance mixture has passed the unguided flow region, for example from the reservoir region towards the outlet.

According to at least one embodiment, the method further comprises the step of moving the fluid substance mixture through a free fall or a free flow region. The free fall or free flow region may be the unguided flow region.

According to at least one embodiment, the fluid handling system is configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region, in the directing region, at the first inlet, at the second inlet and/or at the outlet, which is characterized by a calculated Reynolds number (Re) of less than or equal to one of the following values: 10000, 7500, 5000, 4000, 3000, 2900, 2800, 2700, 2600, 2500.

According to at least one embodiment, the fluid handling system is configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region, in the directing region, at the first inlet, at the second inlet and/or at the outlet, which is characterized by a calculated Reynolds number (Re) of greater than or equal to one of the following values: 500, 1000, 1100, 1200, 1300, 1400, 1500, 1700, 1800, 1900, 2000.

According to at least one embodiment, the fluid handling system may be operated with a flow rate of greater than or equal to 100 mL/min, 200 mL/min, 300 mL/min, 400 mL/min, 500 mL/min, 600 mL/min, 700 mL/min, 800 mL/min, 900 mL/min, 1000 mL/min, 2 L/min, 5 L/min, 10 L/min, 20 L/min, 50 L/min, 80 L/min, 100 L/min.

According to at least one embodiment, the fluid handling system may be operated with a flow rate of less than or equal to 150 L/min, 100 L/min, 80 L/min, 50 L/min, 20 L/min, 10 L/min, 5 L/min, 2 L/min, 1100 mL/min, 1000 mL/min, 900 mL/min, 800 mL/min, 700 mL/min, 600 mL/min, 500 mL/min, 400 mL/min, 300 mL/min, 200 mL/min.

The fluid handling system may be operated with a flow rate between 100 mL/min and 1100 mL/min, for example of between 200 mL/min and 150 L/min, for example of ca. 700 mL/min or 2 L/min or 5 L/min.

The operating flow rate values of the fluid handling system may relate to the flow rate of the fluid substance mixture and/or to the flow rates of the first fluid substance and/or of the second fluid substance.

According to at least one embodiment, the method is performed with the fluid path system of the present disclosure.

According to another aspect, the present disclosure relates to the use of the fluid handling system of the present disclosure for mixing a first fluid substance with a second fluid substance to provide a fluid substance mixture.

According to another aspect, the present disclosure relates to a fluid substance mixture obtainable or obtained by the method of processing fluids as described further above or below or the use.

According to another aspect, the present disclosure relates to a nanoparticle composition, e.g. lipid or liposome nanoparticles (LNPs) composition, such as nucleic acid LNPs, Lipoplex (LPX) composition or Polyplexes (PPX) composition, such as an RNA-LPX composition, obtainable or obtained by the method described further above or below or the use.

### BRIEF DESCRIPTION OF THE DRAWINGS

FIG. 1a shows an exemplary clogging in a system;

FIG. 1b shows a detailed view of an exemplary clogging in a system;

FIG. 1c shows size and polydispersity index values for the fluid substance mixture product;

FIG. 1d shows RNA content over time for conventional mixing processes;

FIG. 1e shows an amount of subvisible particles with larger process volumes for different tubing materials;

FIGS. 2a, 2b show two fluid handling system according to at least two different embodiments of the present disclosure;

FIGS. 3a, 3b, 3c show exemplary embodiments of a fluid handling system;

FIG. 4 shows a further exemplary embodiment of a fluid handling system;

FIG. 5 shows an exemplary embodiment of a method for processing fluids;

FIG. 6a shows particle sizes determined by photon correlation spectroscopy (PCS) in a fluid substance mixture product for different process volumes;

FIG. 6b shows RNA content (mg/mL) in a fluid substance mixture product for different process volumes;

FIG. 6c shows the amount of subvisible particles in the fluid substance mixture product for increasing process volume.

### DESCRIPTION OF THE EXEMPLARY EMBODIMENTS

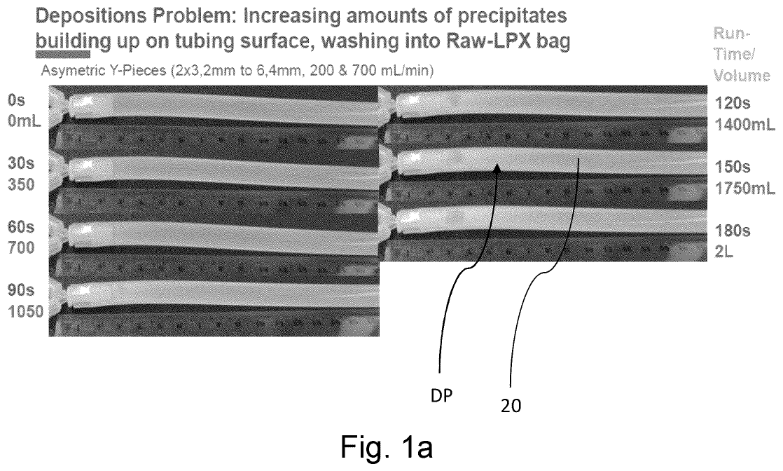

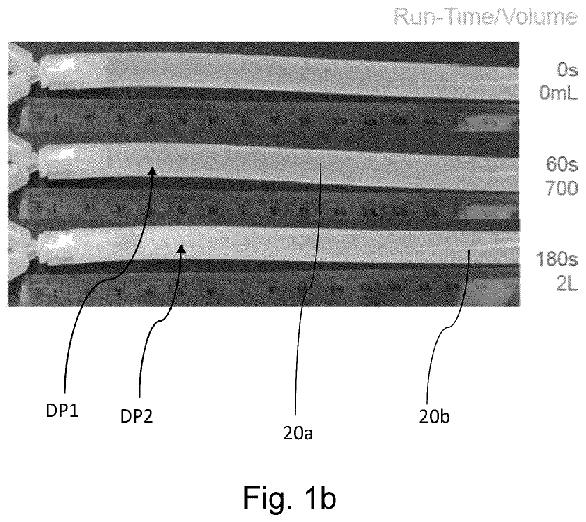

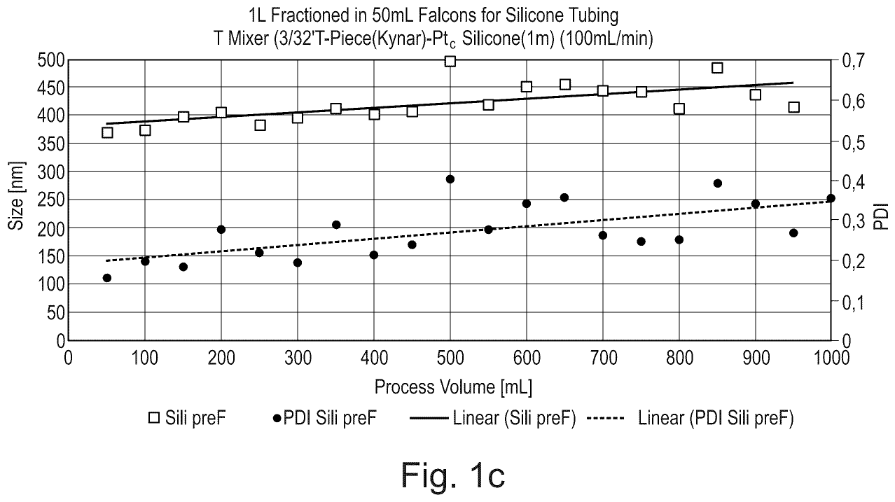

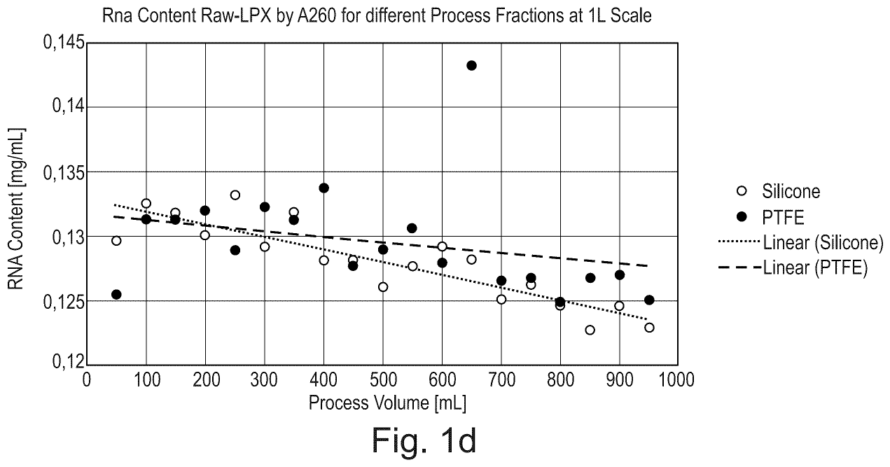

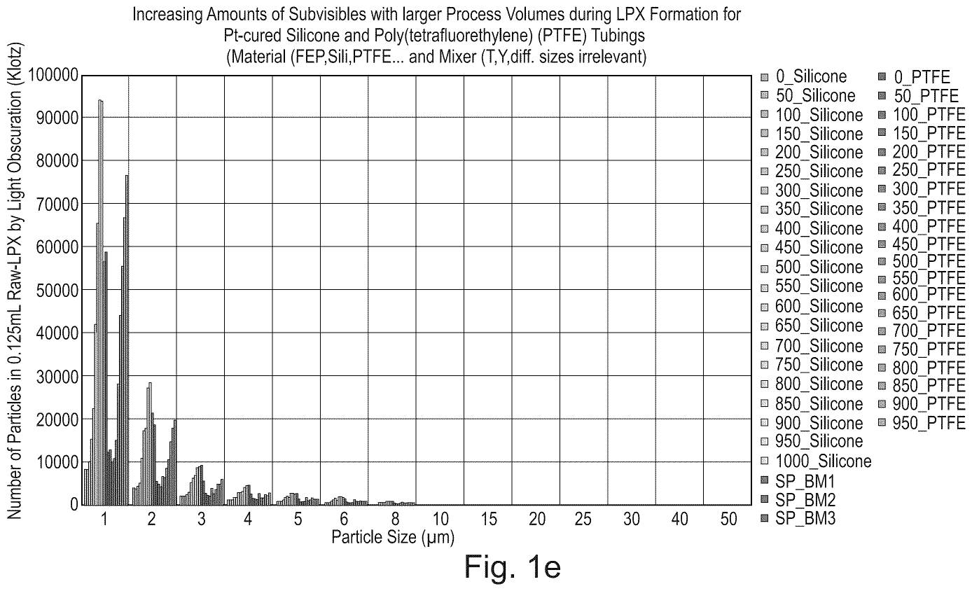

FIG. 1a shows a portion of a fluid handling system in which two fluids have been mixed together already to form a fluid substance mixture.

The figure shows different stages during the runtime of the system while continuously mixing first and second fluid substances and generating fluid substance mixture. The tube at the top shows the state of the system before the mixing process has been initiated. In the figures an increased and visible amount of material DP is deposited in the tubes 20 (in this figure only marked for one tube 20 after 150 seconds of run-time and 1750 mL of fluid substance mixture volume).

A more detailed explanation of the different stages of the system is shown and explained with respect to FIG. 1b in which a stage at the start (0 seconds run-time and 0 mL fluid substance mixture volume), after 1 minutes (60 seconds run-time and 700 mL fluid substance mixture volume) and after 3 minutes (180 seconds run-time and 2 L fluid substance mixture volume) is shown.

FIG. 1b shows two tubes 20a, 20b, in which two fluid substances have been mixed together (the mixing region, where the mixing occurred is slightly shown in the left side of the figure but will be explained in more detail below). The two tubes represent different stages during the runtime of the system while continuously mixing first and second fluid substances. The tube at the top (not labelled) shows the state of the system before the mixing process has been initiated.

As shown, in the tube 20a, after just a minute run-time (60 seconds) and 700 ml fluid substance mixture volume, a visible amount of material DP1 can be seen in the tube, i.e. tube 20a. Thus, the fluid path guiding the fluid substance mixture may clog or occlude over time as the amount of deposit on the inner walls of the system increases. After 3 minutes (180 seconds) run-time and 2 L fluid substance mixture volume, the material DP2 in the tube, i.e. in tube 20b, has increased even more.

The clogging may eventually lead to a completely occluded outlet tube 20. This will interrupt the production of the fluid substance mixture. This clogging may occur particularly when the fluid substance mixture, resulting from two fluids that are mixed together, has a transition state, e.g. an intermediate state (called colloquially “Sticky phase”), directly after the mixing of the two fluids.

In some cases, only partial clogging may occur because the deposition formed is washed away. When the deposition is washed away it might end up in the final product, e.g. the fluid substance mixture. This is disadvantageous as it modifies the size-distribution of the nanoparticles over time (e.g. uneven distribution of particle size) resulting in less yield and a less homogeneous end-product (e.g. fluid substance mixture) over time. In FIG. 1B the material DP1 and DP2 seen is being washed away. The washed-up deposition modifies the particle distribution in the fluid substance mixture in an inhomogeneous way. This effect is a very undesirable effect.

The fluid substance mixture may comprise nanoparticle, e.g. lipid or liposome nanoparticles (LNPs), such as nucleic acid LNPs, Lipoplexes (LPX) or Polyplexes (PPX). The nanoparticle may comprise RNA, such as mRNA, e.g. encapsulated by lipids and/or polymers. It has been found that fluid substance mixtures suitable for the formation of nanoparticles compositions have a particular tendency to exhibit a transition or sticky phase.

Another problem encountered in the systems may be, for example, the formation of particles with increased sizes and/or an increased inhomogeneity in the sizes of the formed nanoparticles, e.g. evident by an increase in the polydispersity index (PDI), in the fluid substance mixture. This may lead to a less homogeneous product and even cause the product to be outside set tolerances (see, e.g. FIG. 1c). For nucleic acid LNPs, e.g. RNA-LNPs, or for nucleic acid Lipoplexes, e.g. RNA-LPX the PDI should be below a predetermined value (e.g. 0.4 or less or 0.3 or less) and/or not change significantly with increasing process volume.

If the fluid substance mixture comprises RNA-LPXs, then mixtures produced in such systems may exhibit a decreased RNA content and in particular a drop of RNA concentration with increased processed volume. Thus, some key attributes of the product may change significantly with increasing processed volume of fluid substance mixture. As can be seen from FIGS. 1c and 1d with conventional mixing processes, which may employ a T-, Y-, or X-mixing component with tubings for the inlet and a tubing for the fluid substance mixture at the outlet of the component, the particle properties changed considerably, e.g. with increasing process volume. Notably, the materials of the used elements, i.e. tubings and components, did not have a significant effect on key attributes (see e.g. FIG. 1e).

In one possible example the first fluid substance may comprise a buffered RNA, more specific: BNT162b2 RNA at 0.3 mg/mL, at 18 mM HEPES and EDTA, with a pH 7 (NaOH). The second fluid substance may comprise Liposomes, more specific L6 Liposomes at 0.6 mM DOTMA and Acetic Acid 1.1 mM with ca. 550 nm average size.

However, it has been found that other fluid substances may also exhibit an increased tendency to form deposits on the walls of the structural elements guiding the fluid substance mixture, e.g. shortly after the first and second fluid substances have been mixed (see the summary section of the description).

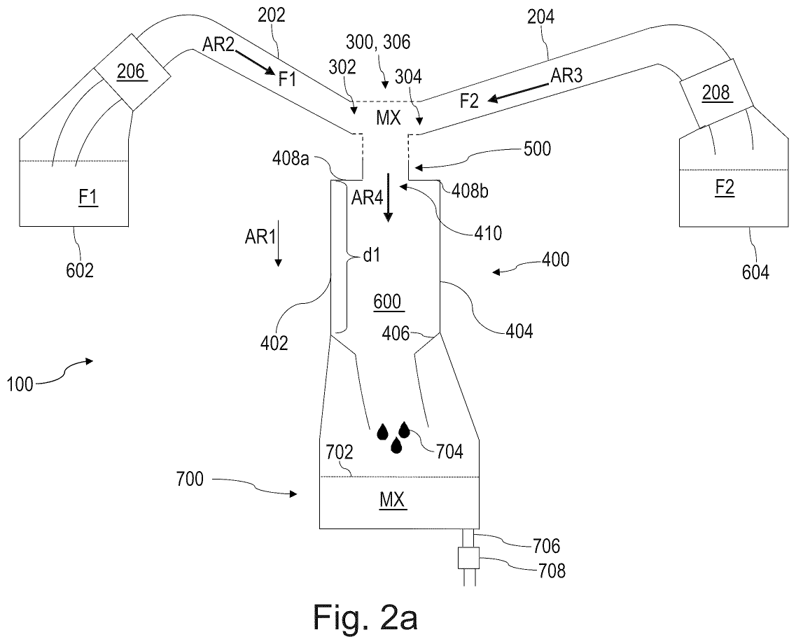

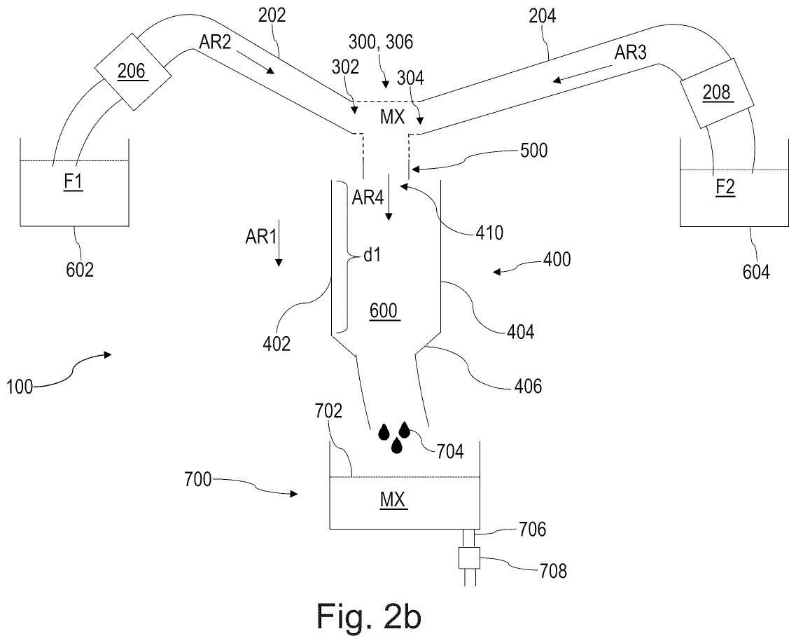

FIG. 2a shows an exemplary embodiment of fluid handling system 100 of the present disclosure.

The fluid handling system 100 comprises a fluid path system, e.g. a closed fluid path system (e.g. sealed off from the environment between inlet(s) and outlet(s) of the fluid path system), comprising a first fluid path 202 for guiding a first fluid substance F1 towards a mixing region 300 of the fluid path system, and a second fluid path 204 for guiding a second fluid substance F2 towards the mixing region 300.

The mixing region 300 is arranged to be in fluid communication with the first fluid path 202 and the second fluid path 204 such that the first fluid substance F1 and the second fluid substance F2 can be mixed in the mixing region 300 to form a fluid substance mixture MX. The fluid handling system 100 may be configured so as to provide a turbulent mixing of the first fluid substance and the second fluid substance in the mixing region 300.

The mixing region 300 comprise a first inlet 302 for the first fluid substance F1 and a second inlet 304 for the second fluid substance F2. The mixing region may be formed by a mixing component. Tubings may be connected to the inlets and the outlet of the mixing component to guide the respective liquid or fluid.

The mixing component 306 (shown for clarity through dashed lines) may be connected to a first tubing 202. The first tubing 202 may define the first fluid path 202. The mixing component 306 may be connected to a second tubing 204. The second tubing 204 may define the second fluid path 204. The first tubing 202 may be plugged onto the first inlet 302 of the mixing region 300, e.g. of the mixing component 306. The second tubing 204 may be plugged onto the second inlet 302 of the mixing region 300, e.g. of the mixing component 306. The first and second fluid path may have the same diameter (e.g. a minimum, maximum or average diameter), for example 4 cm or 5 cm.

The mixing region 300 may be provided by a section of a continuous tubing structure (in this case a separate mixing component is not needed). The tubing structure may comprise further sections providing the first fluid path 202 and/or the second fluid path 204. The first and second fluid paths 202, 204 may be fluidically separated from one another. The first and second fluid path 202, 204 may be fluidically separated from one another up to the mixing region 300.

The mixing component 306 is in this example substantially T-shaped as shown by the dashed lines in the figure (i.e. the component may be a T-mixer). Other shapes are also possible for the mixing component, e.g. a Y-shape, a X-shape or a psi-geometry. The mixing component 306 may be configured such that, when the first tubing 202 and the second tubing 204 are connected to (e.g. plugged to) the mixing component 306 the first flow direction and the second flow direction define an angle. The angle may for example be between 45° and 315°, for example 60°. The angle may be different from 180°.

However, having the first and second fluid impinging one another with opposite flow directions as in the T-mixer may enhance mixing in the mixing region. The mixing component may comprise an outlet directed towards the unguided flow region 400. In this example the outlet of the mixing component is part of a directing region 500 (see below).

The structure for the first fluid path 202, the second fluid path 204 (e.g. tubings) and/or the mixing region 300 (and/or the mixing component 306) may be made of or comprise plastic, e.g. medical grade plastic and/or polypropylene or polyvinylidene fluoride (PVDF), or non-plastic materials e.g. medical grade materials such as stainless steel.

The fluid handling system 100 further comprises an unguided flow region 400. The unguided flow region 400 is configured such that the fluid substance mixture MX is prevented from contacting an inner wall 402, 404 (e.g. any inner wall) suitable for guiding a flow of the fluid substance mixture MX along a flow direction AR1 of the fluid substance mixture MX while the fluid substance mixture MX travels through the unguided flow region 400. In the depicted embodiment, the unguided flow region 400 has an increased inner diameter (e.g. a minimum, maximum or average diameter) as opposed to the element adjoining the unguided flow region in the upstream direction. The element adjoining the unguided flow region, e.g. the outlet of the directing region) may have a diameter (e.g. a minimum, maximum or average diameter) which is at least or less than halve of the inner diameter of the unguided flow region. The unguided flow region may for example have an inner diameter of 20 cm while the diameter of the outlet of the directing region may be 0.64 cm.

The unguided flow region 400 extends for a predetermined distance, e.g. only for the predetermined distance. The unguided flow region 400 may extend for a predetermined distance downstream of the mixing region 300. The predetermined distance might be the distance d1 shown in FIG. 2a. In this example the distance d1 corresponds to the extension of the inner wall 402. Distance d1 may for example be between 5 cm and 565 cm, for example 165 cm, 68 cm, 35 cm, 25 cm or 20 cm.

It has been found that reducing the likelihood or preventing the possibility of the fluid substance mixture MX contacting an inner wall, e.g. directly after or shortly after the mixing process has been performed, may be beneficial, e.g. but not restricted, to the formation of RNA-LPXs (see further below). Hence, providing a fluid handling system with such an unguided flow region provides an improved system.

In the example in FIG. 2a, a fluid guiding element 406 of the fluid handling system 100 is positioned downstream of the unguided flow region 400 to guide the fluid substance mixture MX. Alternatively, or additionally, a fluid retaining element (not shown) of the fluid handling system 100 may be positioned downstream of the unguided flow region 400 to receive the fluid substance mixture MX.

As exemplarily shown in FIG. 2a the first fluid path 202 and the second fluid path 204 may be arranged such that the first fluid substance F1 and the second fluid substance F2 can be moved simultaneously into the mixing region.

The flow AR2 of the first fluid substance F1 in the first fluid path and/or the flow AR3 of the second fluid substance F2 in the second fluid path 204 may be driven by a respective first and/or second flow driver, such as a pump, e.g. a diaphragm pump (see flow drivers 206 and 208). Optionally, a further flow driver 708 (e.g. a pump) may be arranged downstream of the unguided flow region 400, so as to drive the flow of the fluid substance mixture MX after the mixture has passed the unguided flow region 400. Between an inlet of the unguided flow region and its outlet, there may be a region which is not completely filled with liquid or fluid substance mixture. Hence, the first and second flow drivers may not be sufficient to drive flow of the liquid substance mixture downstream of the unguided flow region.

As shown in FIG. 2a, the fluid handling system 100 further comprises a directing region 500. The directing region may be arranged between the mixing region 300 and the unguided flow region 400 seen along the flow direction AR1. The directing region 500 may be configured to determine, e.g. to set, an entry flow direction AR4 of the fluid substance mixture MX. The entry flow direction AR4 may be the flow direction with which the fluid substance mixture MX enters the unguided flow region 400.

The directing region 500 may be particularly advantageous in cases where the fluid handling system 100 is arranged such that gravity could change the flow direction of the fluid substance mixture after entering the unguided flow region 400. If the fluid substance mixture flows vertically or along gravity as shown in the FIG. 2a, the directing region may not be as advantageous but could still have a positive directional effect on the flow into the unguided flow region 400, e.g. as the flow in the mixing region 300 may be more turbulent than in the unguided flow region 400.

In other cases, where the flow direction in the unguided flow direction can be changed by gravity, the directing region may define the entry flow direction of the fluid substance mixture MX into the mixing region 300, e.g. The mixing region 300 is configured to or directly directs the fluid mixture flow into the unguided flow region 400 in a way so as to not contact any inner wall (see 402 and 404) during the flow through the unguided flow region 400. The directing region 500 may be about 2 cm long.

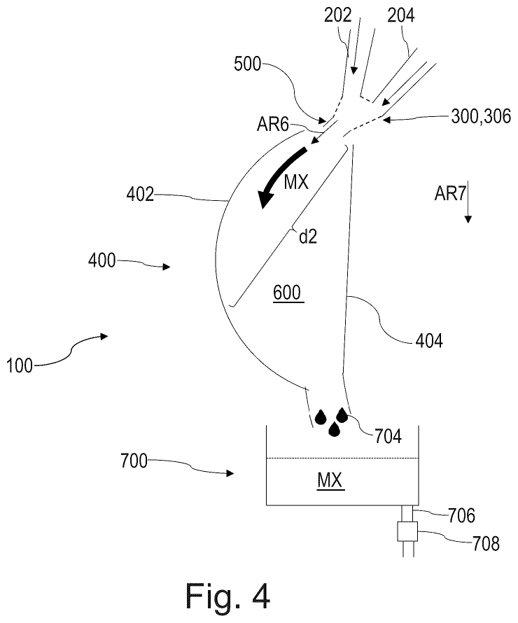

In the exemplary embodiment of FIG. 2a the entry flow direction AR4 is parallel to the main axis of the unguided flow region and oriented along the gravitational force. Alternatively, the entry flow direction AR4 may be angled with respect to a main axis of the unguided of region 400 and/or with respect to the gravitational force (see, e.g., FIG. 4, arrow AR6 with respect to AR7).

As shown in FIG. 2a, the fluid path of the fluid path system guiding the fluid substance mixture MX widens (denoted with reference numerals 408a, 408b), as seen along the flow direction from the mixing region 300 towards the unguided flow region 400, along the flow direction away from the mixing region 300, e.g. at the end of the directing region 400.

For the predetermined distance d1 of the unguided flow region 400, the fluid handling system 100, may comprise a free fall region 600 or free flow region 600 which allows the fluid substance mixture MX to travel within the fluid handling system 100 without contacting the inner wall 402, 404 of the fluid handling system 100, e.g. the inner wall of the unguided flow region 400.

The free fall region 600 may be achieved by the geometry of the unguided flow region 400 and optionally through the direction of the fluid substance mixture MX received by the directing region 500.

The fluid path system defines a first flow direction AR2 for a flow of the first fluid substance F1 from the first fluid path 202 into the mixing region 300 through a first inlet. The fluid path system defines a second flow direction AR3 for a flow of the second fluid substance F2 from the second fluid path 204 into the mixing region 300 through a second inlet. The first flow AR2 direction and the second flow direction AR3 may for example define an angle of 120°.

In this example the unguided flow region 400 may have an entry region 410. The entry region is the region of the unguided flow region in which the fluid substance mixtures enters the unguided flow region. The mixing region 300 may additionally or alternatively comprise an outlet for the fluid substance mixture. In this example the outlet of the mixing region is 2 mm wide (not shown).

In this particular example the entry region 410 of the unguided flow region adjoins (or coincides) with the outlet of the directing region 500.

The unguided flow region 400 in this example may be 35 cm long. The unguided flow region 400 may be chosen such that the fluid substance mixture MX can be or is prevented from contacting the inner wall 402, 404 of the unguided flow region 400 for a predetermined period of time, e.g. 5 ms, during operation of the fluid handling system 100. The extension of the unguided flow region may be chosen such that, at a given flow rate there is sufficient time for the substance mixture to assume its stable state or at least significantly reduce its tendency to form deposits on an inner wall.

The fluid handling system 100 is further configured to be operated with a flow rate and/or to have a diameter (e.g. a minimum, maximum or average diameter) of the flow path such that, for water having a density of 1 g/cm³, a viscosity of 1 cP and a temperature of 20° Celsius, the relationship between the flow rate and the diameter of the flow path results in a flow in the mixing region 300, in the directing region 500, at the first inlet, at the second inlet and/or at the outlet which is characterized by a calculated Reynolds number (Re) of 1100.

The first fluid substance F1 and the second fluid substance F2 may be chosen such that the fluid substance mixture MX resulting from mixing the first fluid substance F1 and the second fluid substance F2 has an intermediate state, e.g. a temporary state or a transition state. The intermediate state may occur e.g. during and/or directly after mixing of the first fluid substance F1 and the second fluid substance F2.

The intermediate state may only exist for less than a predetermined time period. After the intermediate state the fluid substance mixture MX may assume a stable state. The fluid substance mixture MX, in its intermediate state, may have a greater tendency to form a deposit on a wall, e.g. an inner wall delimiting a fluid path, than in the stable state. An example of this tendency to form a deposit and the related problem of tube clogging are shown in FIG. 1 depicting an exemplary clogging of a system.

The flow handling system 100 is configured to and/or operable in such a way that the fluid substance mixture MX, in its intermediate state, only flows in the mixing region 300 and/or in the unguided flow region 400 and/or, optionally, in the directing region 500.

The first fluid substance F1 and the second fluid substance F2 may be chosen so as to form a fluid substance mixture MX comprising colloids. The colloids may have an average particle size of greater than or equal to 10 nm or less than or equal to 1000 nm, for instance of between 200 and 500 nm, such as around 400 nm, when mixed together. The size of the particles, e.g. for nucleic acid LPXs, such as RNA-LPXs, may depend on the size of the structure which the lipids encapsulate. Hence, smaller or larger diameters or particle sizes may occur.

The first fluid substance F1 may comprise RNA, e.g. it may be an RNA solution. The second fluid substance F2 may comprise liposomes or lipoplexes. One or both fluid substances F1 and F2 may be buffered. When the substances are mixed, RNA-LPXs or RNA-LNP may be formed.

The first and second fluid substances F1 and F2 may be for example an ionic substance, e.g. a cationic or an anionic substance or a cationic and anionic substance. The first and/or second fluid substance mixture may be for example an ionizable substance. The first and second fluid substances F1 and F2 may be different to each other, e.g. the first fluid F1 substance an anionic substance and the second fluid substance F2 a cationic substance.

The first fluid substance F1 may comprise a substance of polymeric nature, e.g. an ionic substance of polymeric nature. The first fluid substance F1 may comprise a nucleic acid, a peptide or a protein.

The second fluid substance F2 may be a colloidal suspension, e.g. an ionic colloidal suspension, such as a cationic colloidal suspension. The second fluid substance F2 may comprise a hydrophilic and/or lipophilic substance, e.g. an amphiphilic substance. The second fluid substance F2 may comprise a lipid. The second fluid substance may comprise a cationic polymer.

The second fluid substance F2 may comprise at least one lipid selected from the group consisting of
(i) an ionizable lipid, preferably an ionizable cationic lipid, such as an ionizable cationic amino lipid, for instance ALC-0315 ((4-hydroxybutyl) azanediyl)bis(hexane-6,1-diyl)bis(2-hexyldecanoate)), or SM-102 (heptadecan-9-yl 8-((2-hydroxyethyl) (6-oxo-6-(undecyloxy) hexyl)amino) octanoate), or DOPE (1,2-dioleoyl-sn-3phosphoethanolamine), or DOTMA (N-(2,3-dioleyloxy) propyl) N, N,N-trimethylammonium chloride) or DOSPA (N-(1-(2,3dioleyloxy)propyl)-N-(2-(sperminecarboxamido)ethyl)-N,N-dimethylammonium trifluoroacetate);
(ii) a non-cationic helper lipid or phospholipid, such as a neutral lipid and for instance DSPC (1,2-distearoyl-i77-glycero-3-phosphocholine) or an analogue or a substitute thereof;
(iii) a sterol or other structural lipid, for instance cholesterol; and
(iv) a PEG lipid, for instance 1,2-dimyristoyl-snglycerol methoxypolyethylene glycol (PEG-DMG). Other lipids may also be suitable to be comprised by the second fluid. Further alternatives to PEG Lipids may be (but are not limited to) polysarcosine, polyoxazolin, non-charged lipid e.g., pSar or pMeOx.

Both the first and the second fluid substance may be colloidal suspension, e.g. ionic colloidal suspensions. The first fluid substance may be or may comprise a polymeric amphiphilic substance or a polymeric lipophilic substance or a polymeric hydrophilic substance. The second fluid substance may comprise an amphiphilic or a polymeric amphiphilic substance or a polymeric lipophilic substance or a polymeric hydrophilic substance.

Both the first and the second fluid substance may be a pharmaceutical substance, e.g. a biopharmaceutical substance. At least one of or both of the first fluid substance and the second fluid substance may be an aqueous composition, e.g. an aqueous solution or an aqueous dispersion. At least one of or both of the first fluid substance and the second fluid substance may be a solution. At least one of or both of the first fluid substance and the second fluid substance may be a dispersion. The first fluid substance may be an aqueous composition, e.g. an aqueous solution or an aqueous dispersion, and the second fluid substance may be an organic composition, e.g. organic solution or dispersion. The organic composition may comprise more than 1%, 10%, 25%, 50% of an organic solvent.

One of or both of the first fluid substance and the second fluid substance may be medical fluid substances.

All the above described combinations of first fluid substances F1 and second fluid substances F2, when mixed together to form a fluid substance mixtures MX, may have a tendency to exhibit an intermediate state (e.g. a sticky phase). As such the advantages described with respect to the system of the present disclosure apply for all these fluids.

Such an intermediate state, e.g. a sticky phase, can occur for all mixtures of charged polymers/lipids. Layer-by-layer deposition upon start of deposition of material in the mixing region is experienced indeed for all mixtures of charged molecules. During the mixing phase sticky and colloidally instable intermediates are formed until complete saturation of one of the two fluid substances with the other fluid substance, e.g. the first or the second fluid substance, resulting in stabilization/passivation of the nanoparticles.

For LNPs of N/P ratio (e.g. the ratio of positively-chargeable polymer amine (N=nitrogen) groups to negatively-charged nucleic acid phosphate (P) groups) greater than 1 the process might be on a different timescale, Since the LNPs are most likely formed out of Lipid in ethanolic solution or micellar intermediate structures with lipid excess. While the Liposomes characteristics used in the LPX process effect the particle distribution in size and the rearrangement of the pre-existing structure might be what causes this intermediate instable state.

In one possible example the first fluid substance may comprise a buffered RNA, more specific: BNT162b2 RNA at 0.3 mg/mL, at 18 mM HEPES and EDTA, with a pH 7 (NaOH). The second fluid substance may comprise Liposomes, more specific L6 Liposomes at 0.6 mM DOTMA and Acetic Acid 1.1 mM with ca. 550 nm average size.

As shown in FIG. 2a the first fluid path 202 is fluidly connected to or fluidly connectable to a first reservoir 602. The first reservoir 602 may comprise the first fluid substance F1. The first fluid substance F1 may be driven from the first reservoir 602 towards the mixing region 300 through the first fluid path 202. The second fluid path 204 may be fluidly connected to or fluidly connectable to a second reservoir 604. The second reservoir may comprise the second fluid substance F2 such that the second fluid substance F2 can be driven from the second reservoir 604 towards the mixing region 300 through the second fluid path 204.

The fluid handling system 100 may further comprise a reservoir region 700, e.g. a container, for example a bag, for collecting the fluid substance mixture MX. The reservoir region may have a capacity of 10 L. The reservoir region 700 may be arranged downstream of the unguided flow region 400 as seen along the flow direction AR1 of the fluid substance mixture MX in the fluid handling system 100. The fluid substance mixture MX in the reservoir region 700 forms a surface 702. The surface 702 may delimit the reservoir region 700, e.g. on the side facing the unguided flow region 400 as seen in the direction opposite to the flow direction AR1 of the fluid substance mixture MX towards the reservoir region 700. After having travelled through the unguided flow region 400, the fluid substance mixture MX may enter the reservoir region 700. The fluid substance mixture MX may enter the reservoir region 700 via the surface 702, e.g. in the form of fluid drops 704 impinging on the surface.

The fluid handling system 100 may further comprise a reservoir region outlet 706. The reservoir region outlet 706 may be in fluid communication with the reservoir region 700. The reservoir region outlet 706 may be provided to remove content, e.g. the fluid substance mixture MX, from the reservoir region 700.

A mixture flow driver 708 may be operatively coupled to the reservoir region, e.g. connected to the reservoir region outlet 706. The mixture flow driver 708 may be used to provide a flow (e.g. an extraction) of the fluid substance mixture MX away from the reservoir region 700.

The reservoir region 700 may be comprised in the fluid path system. The reservoir region may be directly connected to the unguided flow region 400. The reservoir region may be a region in the fluid path system downstream of the unguided flow region and immediately adjoining the unguided flow region.

One or more further fluid substances may be added to the mixture in the reservoir region, e.g. to the container, downstream of the unguided flow region 400 and/or in the container 700 through a port (not explicitly shown).

From the reservoir region 700, the fluid substance mixture MX may be continuously withdrawn, for example downstream of the unguided flow region 400 via flow driver 708. The fluid substance mixture may be

The fluid handling system 100 may further comprise an agitator, e.g. a magnetic agitator. The agitator may be arranged in the content to be agitated, to agitate the fluid substances. The agitator may be arranged in the reservoir region to agitate, e.g. the fluid substance mixture MX in the reservoir region (not shown).

FIG. 2b shows a different exemplary embodiment of a fluid handling system 100. The fluid handling system 100 of FIG. 2b is substantially similar to the fluid handling system 100 described for FIG. 2a. Same reference signs refer to the same features. Only the differences with respect of the fluid handling system 100 of FIG. 2b with respect to the one of FIG. 2a will be described.

The fluid handling system 100 in the embodiment of FIG. 2b is an example of an interrupted system. In particular the unguided flow region 400 may be physically disconnected from the mixing region 300. The unguided flow region 400 may be physically disconnected from the directing region 500. The fluid substance mixture MX flowing downstream from the directing region 500 experiences a free fall for the predetermined period of time and for the predetermined distance, during which it does not contact the walls 402, 404 of the unguided flow region.

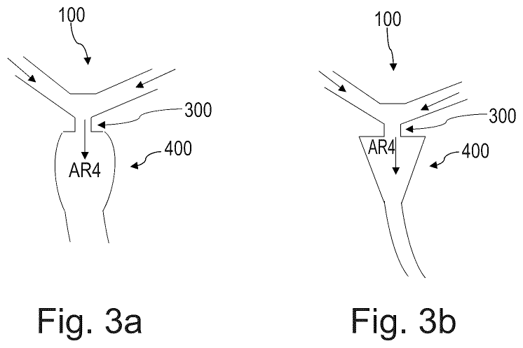

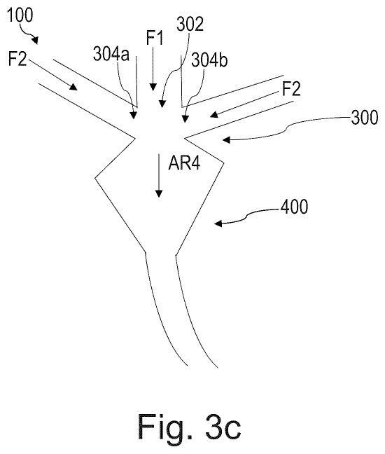

FIGS. 3a, 3b and 3c show further exemplary embodiments of fluid handling systems 100 of FIGS. 2a and 2b. The difference between the different embodiments of FIGS. 3a and 3b is the shape of the unguided flow region 400. The fluid handling system shown in FIG. 3c instead comprises a different shape of the unguided flow region and a different shape of the mixing region 300 and/or directing region 500.

The diameter of the mixture fluid path in the unguided flow region 400 varies in the embodiments of FIGS. 3a and 3b. In FIG. 3a the diameter of at least one section of the mixture fluid path increases in the unguided flow region 400 in a direction away from the mixing region 300, e.g. in the fluid mixture flow direction AR4 exiting the directing region 500.

In FIG. 3b the diameter of the mixture fluid path decreases in a direction away from the mixing region 300 in the unguided flow region 400 instead, at least in a section of the mixture fluid path.

FIG. 3c shows an exemplary embodiment of a fluid handling system 100 comprising two inlets, e.g. two second inlets 304a, 304b for the second fluid substance F2 and one inlet, e.g. one first inlet 302, for the first fluid substance F1. The mixing region 300 may have a X-shape or a psi geometry.

In an additional or alternative example, inlet 304b may by a third inlet 304b for a third fluid substance, e.g. a gas such as air, in a third fluid path.

The diameter of the mixture fluid path in the unguided flow region 400 first increases and then decreases in a direction away from the mixing region 300, at least in a section of the mixture fluid path.

FIG. 4 shows a further exemplary embodiment of a fluid handling system 100. In this example the first fluid path 202, the second fluid path 204, the mixing region 300 and the directing region 500 are substantially tilted clockwise, e.g. by about 20 degrees, with respect to the embodiments in the prior figures. The outlet of the directing region 500 may be tilted e.g. by 20 degrees, anti-clockwise or clockwise. Each element may be independently arranged in a tilted or not tilted position. The degrees with which the elements are tilted may vary for each element or just for some elements.

In this embodiment, the entry flow direction AR6 is angled with respect to a main axis AR7 of the unguided flow region 400. The main axis may be oriented along the direction of the gravitational force.

In embodiments like this, i.e. in which the outlet of the mixing region and/or the directing region is not directly orientated straight downwards but angled by a certain degree with respect to the main downstream direction, the unguided flow region may be adapted to assure an unguided flow of the fluid substance mixture, e.g. a flow of the fluid substance mixtures for a predetermined period of time in which it does not contact the inner walls 402 and 404 of the unguided flow region 400.

The change of direction of the fluid substance mixture in or shortly before the unguided flow region once passed the directing region is obtained by gravitational force. The change of direction of the fluid substance mixture MX is shown in FIG. 4 (illustrated by a curved arrow and the reference sign MX).

In this embodiment, for example, the inner wall 402 of the unguided flow region may be arranged in such a way to guarantee that the fluid substance mixture MX exiting the directing region 500 does not contact the inner wall 402 for the predetermined period of time and/or for the predetermined distance d2. The inner wall 402 may be configured to have a concave shape as in the example of FIG. 4 (as seen from the interior). The distance d2 may correspond to the distance d1 of FIG. 2a.

Distance d2 may be between 5 cm and 565 cm, for example 165 cm, 68 cm, 35 cm, 25 cm or 20 cm.

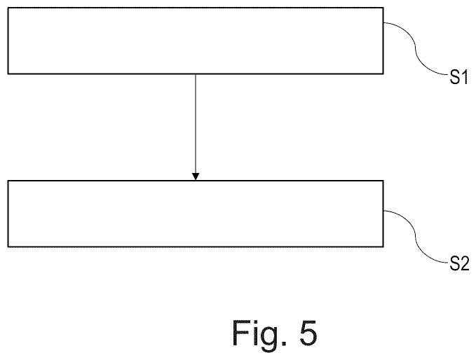

FIG. 5 shows a schematic diagram of an exemplary embodiment for a method for processing fluids. Features in the method may be referred to by the same reference signs used for describing the fluid handling system. The method is, however, not limited to the use of the fluid handling system 100 of the previous figures.

In a first step S1 of the method, a first fluid substance F1 and a second fluid substance F2 within a fluid path system are guided to a mixing region 300 to form a fluid substance mixture MX. In particular, guiding the first fluid substance F1 to the mixing region 300 may comprise guiding the first fluid substance F1 through a first fluid path of the fluid path system. Guiding the second fluid substance F2 to a mixing region 300 may comprise guiding the second fluid substance F2 through a second fluid path of the fluid path system.

The first fluid substance F1 and the second fluid substance F2 may be guided simultaneously into the mixing region 300. The fluid flow of the first fluid substance F1 and/or of the second fluid substance F2, e.g. towards the mixing region 300, may be achieved via a first flow driver and/or a second flow driver respectively.

The first flow driver and/or the second flow driver may be, for example, peristaltic pumps. Alternatively, the first flow driver may be different from the second flow driver. The first flow driver may, for example, be a syringe pump, while the second flow driver may be a diaphragm pump, or vice versa.

The first fluid substance F1 and the second fluid substance F2 may be chosen such that the fluid substance mixture MX resulting from mixing the first fluid substance F1 and the second fluid substance F2 has an intermediate state. The intermediate state may occur. during and/or directly after mixing of the first fluid substance F1 and the second fluid substance F2. The intermediate state of the fluid substance mixture MX may only be a temporary state.

The first fluid substance F1 and the second fluid substance F2 may be guided through the mixing region 300 for a time period of e.g. 40 ms, to form a fluid substance mixture MX.

In a not shown optional step, the method comprises guiding a third fluid substance within the fluid path system, to the mixing region to form the fluid substance mixture. Guiding the third fluid substance to a mixing region may comprise guiding the third fluid substance through a third fluid path of the fluid path system.

In a second step S2 of the exemplary method, contact between the fluid substance mixture MX and a wall 402, 404 of the fluid path system is prevented for a predetermined period of time. This may occur in an unguided flow region 400 along the flow direction AR2 of the fluid substance mixture Mx downstream of the mixing region 300.

The fluid substance mixture MX may have the intermediate state only for less than the predetermined period of time, e.g. the predetermined period of time in which the fluid substance mixture MX is prevented from contacting a wall 402, 404 of the fluid path system.

The method may further comprise the step of guiding the fluid substance mixture MX through a free fall or a free flow region. The free fall or free flow region may, for example, be the or in the unguided flow region 300.

Before the second step S2, the fluid substance mixture MX may be guided through a directing region 500 positioned downstream of the mixing region 300. Guiding the fluid substance mixture MX through the directing region 500 may direct the fluid substance mixture MX towards the unguided flow region 300.

The exemplary method may further comprise guiding the fluid substance mixture MX within a fluid guiding element of the fluid path system positioned downstream of the unguided flow region 300. Additionally, or alternatively, the fluid substance mixture MX may be received in a fluid retaining element 700 of the fluid path system positioned downstream of the unguided flow region 300.

Guiding the fluid substance mixture MX within a fluid guiding element of the fluid path system positioned downstream of the unguided flow region 300 may, for example, be achieved by means of another mixture flow driver, being for example a pump, e.g. a piston pump.

The fluid handling system 100 may be configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region 300, in the directing region 500, at a first inlet of the first fluid path, at a second inlet of the second fluid path and/or at an outlet of the mixing region which is characterized by a calculated Reynolds number (Re) of 1100.

The exemplary method described may be performed with the fluid path system of any one of the above described embodiments.

The fluid handling system may for example be used for mixing a first fluid substance F1 with a second fluid substance F2 to provide fluid substance mixture MX.

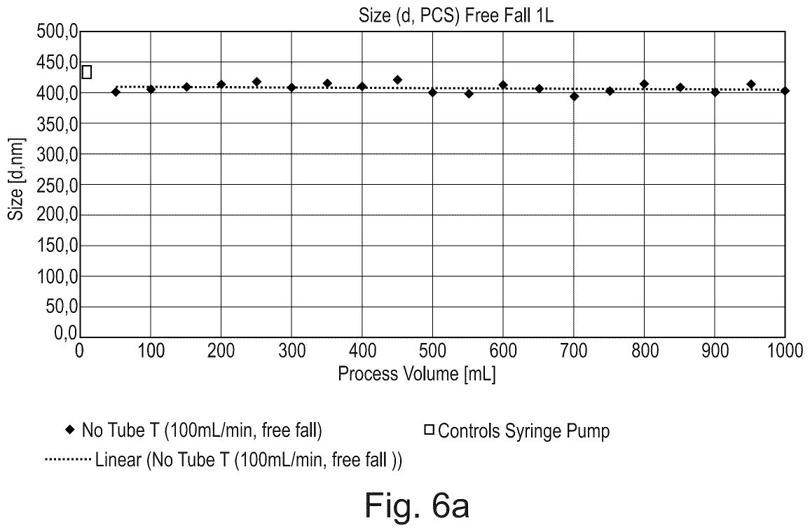

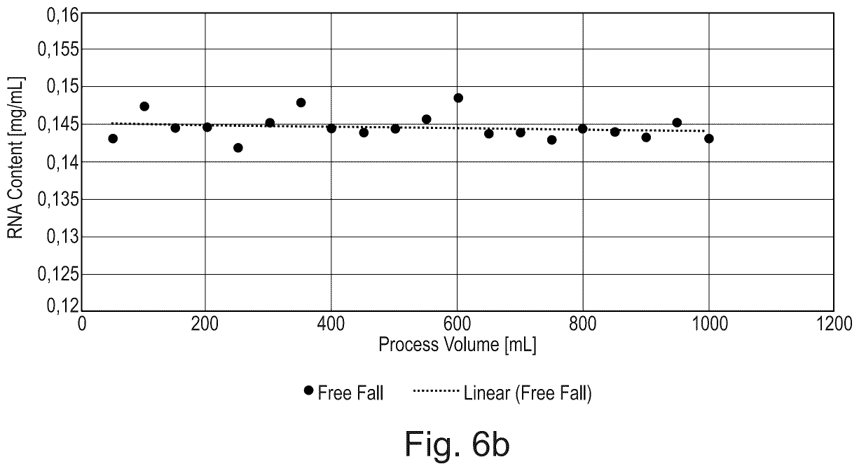

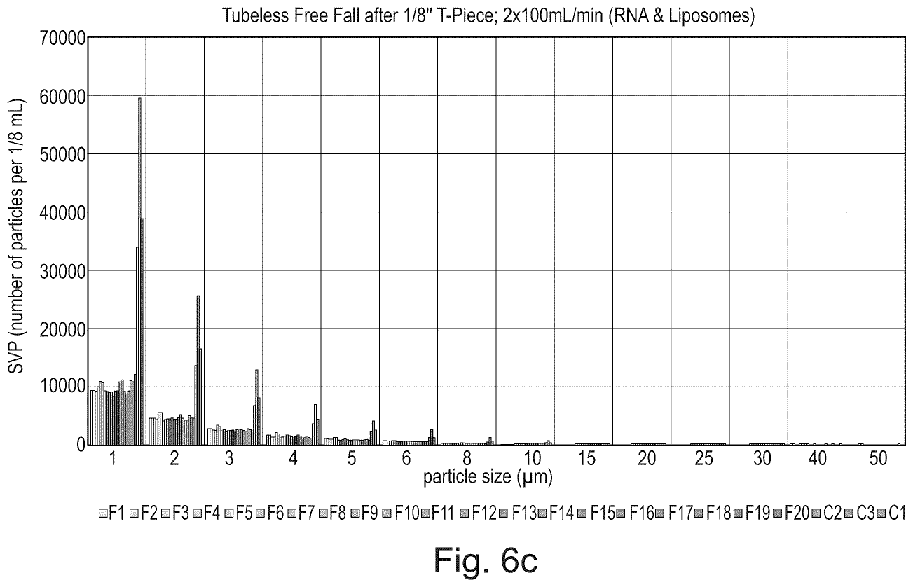

FIGS. 6a to 6c show the beneficial effects of the fluid handling system(s) of the disclosure for the provided fluid substance mixture product.

The graph of FIG. 6a demonstrates that the size of the particles, the particle diameter in nm having been determined by photon correlation spectroscopy (PCS), in the fluid substance mixture processed in the fluid handling system of any of the embodiments of the disclosure, and optionally processed according to the method described in any of the embodiments of the disclosure, remains constant even when increasing process volume. In the legend the “no Tube T” indicates that a free fall region was provided, e.g. that the fluid handling system of the present disclosure with a free fall region was used.

As can be seen a constant particle size (e.g. an average diameter) of around 400 nm can be achieved with the fluid handling system of the present disclosure.

The graph in FIG. 6b shows that, if the fluid substance mixture comprises RNA, the RNA content, i.e. the RNA concentration (mg/mL), remains substantially constant with increasing process volume.

These results suggest that a constant product quality of the fluid substance mixture can be achieved with the fluid handling system(s) of the disclosure, even with varying process volumes.

FIG. 6c shows the amount of subvisible particles in the fluid substance mixture product manufactured at a pump rate of 200 mL/min (e.g. the first fluid path and the second fluid path each with 100 mL/min process volume) at different stages (e.g. F01 to F20). As illustrated, the amount of subvisible particles in the micrometer-sized range (side-product) remains stable over time and significantly lower than in conventional processes (e.g. syringe pumps) marked with C1, C2 and C3.

The vast improvements over the solution without the unguided flow region (see FIGS. 1a to 1e) are immediately apparent. In particular the number of side-products (e.g. subvisible particles (SVP)) is reduced versus the conventional approach. Furthermore, over time, there is no increase of the number of SVP (which is clearly the case for the conventional method).

Further experimental results have also indicated that there are no quality related changes or trends indicating a significant reduction on the quality of the fluid substance mixture product, e.g. with respect to subvisible particles (SVP), with variations of up to 25% in the volume ratio of the first fluid substance, e.g. RNA, and the second fluid substance, e.g. liposomes.

We note that features disclosed in the summary section of the description do also apply for the description of the exemplary embodiments, even if they are not explicitly reiterated.

Without limiting the present disclosure, a number of embodiments or items of the present disclosure are described below for the purpose of illustration. The items are not claims but could be made subject matter of claims.

Item 1: A fluid handling system, comprising:
a fluid path system, the fluid path system comprising
a first fluid path for guiding a first fluid substance towards a mixing region of the fluid path system,
a second fluid path for guiding a second fluid substance towards the mixing region, wherein
the mixing region is arranged to be in fluid communication with the first fluid path and the second fluid path such that the first fluid substance and the second fluid substance can be mixed in the mixing region to form a fluid substance mixture, wherein
the fluid handling system comprises an unguided flow region, wherein the unguided flow region is configured such that the fluid substance mixture can be or is prevented from contacting an inner wall suitable for guiding a flow of the fluid substance mixture along a flow direction of the fluid substance mixture while the fluid substance mixture travels through the unguided flow region, and wherein
the unguided flow region extends for a predetermined distance, e.g. extends only for the predetermined distance, downstream of the mixing region.

Item 2: The fluid handling system of item 1, wherein a fluid guiding element or fluid retaining element of the fluid handling system is positioned downstream of the unguided flow region to receive and/or guide the fluid substance mixture.

Item 3: The fluid handling system of any one of the preceding items, wherein the fluid handling system is configured such that the first fluid substance and the second fluid substance can be moved into the mixing region simultaneously.

Item 4: The fluid handling system of any one of the preceding items, wherein a diameter (e.g. a minimum, maximum or average diameter) of the first fluid path and/or a diameter (e.g. a minimum, maximum or average diameter) of the second fluid path is greater than or equal to 0.5 mm and less than or equal to 55 mm.

Item 5: The fluid handling system of any one of the preceding items, wherein the fluid flow of the first fluid substance along the first fluid path is drivable or driven by a first flow driver, e.g. a pump, such as a syringe pump, a peristaltic pump, a diaphragm pump and/or a piston pump, or a pressurized vessel.

Item 6: The fluid handling system of any one of the preceding items, wherein the fluid flow of the second fluid substance along the second fluid path is drivable or driven by a second flow driver, e.g. a pump, such as a syringe pump, a peristaltic pump, a diaphragm pump and/or a piston pump, or a pressurized vessel.

Item 7: The fluid handling system of any one of the preceding items, wherein the fluid flow of the fluid substance mixture downstream of the unguided flow region is drivable or driven by a mixture flow driver, e.g. a pump, such as a syringe pump, a peristaltic pump, a diaphragm pump and/or a piston pump, or a pressurized vessel.

Item 8: The fluid handling system of any one of the preceding items, wherein the fluid path system comprises a directing region arranged between the mixing region and the unguided flow region as seen along the flow direction of the fluid substance mixture, wherein the directing region is configured to determine an entry flow direction of the fluid substance mixture with which the fluid substance mixture enters the unguided flow region.

Item 9: The fluid handling system of item 8, wherein the directing region has a length of less than or equal to one of the following values: 5 cm, 4 cm, 3.5 cm, 3 cm, 2.5 cm, 2 cm, 1.5 cm, 1 cm, 0.5 cm, 0.4 cm, 0.3 cm, 0.2 cm.

Item 10: The fluid handling system of item 8 or 9, wherein the directing region has a length of greater than or equal to one of the following values: 0.05 cm, 0.2 cm, 0.5 cm, 1 cm, 1.5 cm, 2 cm.

Item 11: The fluid handling system of any one of items 8 to 10, wherein the entry flow direction is parallel to a main axis of the unguided flow region.

Item 12: The fluid handling system of any one of items 8 to 10, wherein the entry flow direction is angled with respect to a main axis of the unguided flow region.

Item 13: The fluid handling system of any one of items 8 to 12, wherein a fluid path of the fluid path system guiding the fluid substance mixture widens as seen along the flow direction from the mixing region towards the unguided flow region along the flow direction away from the mixing region, e.g. at the end of the directing region.

Item 14: The fluid handling system of any one of the preceding items, wherein, for the predetermined distance, the fluid handling system, e.g. due to an interruption of the fluid path system in the unguided flow region and/or due to a mixture fluid path of the fluid path system being configured with an appropriate width in the unguided flow region, has a free fall region or free flow region which allows the fluid substance mixture to travel within the fluid handling system without contacting the inner wall of the fluid handling system, e.g. the inner wall which is closest to the fluid substance mixture.

Item 15: The fluid handling system of any one of the preceding items, the fluid path system defines a first flow direction for a flow of the first fluid substance from the first fluid path into the mixing region through a first inlet and wherein the fluid path system defines a second flow direction for a flow of the second fluid substance from the second fluid path into the mixing region through a second inlet, wherein the first flow direction and the second flow direction define an angle, and wherein the angle is in a range between 45° and 315°, e.g. in a range between 60° and 300°, e.g. between 120° and 270° or about 180°.

Item 16: The fluid handling system of any one of the preceding items, wherein the mixing region has an outlet for the fluid substance mixture and/or wherein the unguided flow region comprises an entry region.

Item 17: The fluid handling system of item 16, wherein an inner diameter (e.g. a minimum, maximum or average diameter) of the outlet or the entry region is greater than or equal to 0.5 mm and less than or equal to 6 cm, e.g. between 1 mm and 5.2 cm.

Item 18: The fluid handling system of item 16 or 17 with additional reference to item 8 or any item depending on item 8, wherein the entry region of the unguided flow region adjoins or coincides with the outlet of the directing region.

Item 19: The fluid handling system of any one of the preceding items, wherein the predetermined distance is greater than or equal to any one of the following values: 5 cm, 6 cm, 7 cm, 8 cm, 9 cm, 10 cm, 11 cm, 12 cm, 13 cm, 20 cm, 35 cm, 50 cm, 80 cm, 100 cm, 200 cm.

Item 20: The fluid handling system of any one of the preceding items, wherein the predetermined distance is less than or equal to any one of the following values: 565 cm, 400 cm, 300 cm, 200 cm, 165 cm, 68 cm, 35 cm, 13 cm.

Item 21: The fluid handling system of any one of the preceding items, wherein the predetermined distance is chosen such that the fluid substance mixture can be or is prevented from contacting the inner wall for a predetermined period of time, e.g. during operation of the fluid handling system.

Item 22: The fluid handling system of item 21, wherein the predetermined period of time is less than or equal to one of the following: 1 s, 950 ms, 900 ms, 850 ms, 800 ms, 750 ms, 700 ms, 650 ms, 600 ms, 550 ms, 500 ms, 450 ms, 400 ms.

Item 23: The fluid handling system of item 21 or 22, wherein the predetermined period of time is greater than or equal to one of the following: 1 ms, 5 ms, 10 ms, 20 ms, 25 ms, 50 ms, 100 ms, 150 ms, 200 ms, 300 ms.

Item 24: The fluid handling system of any one of the preceding items, wherein the fluid handling system is configured to be operated with a flow rate and/or to have a diameter (e.g. a minimum, maximum or average diameter) of the flow path such that, for water having a density of 1 g/cm³, a viscosity of 1 cP and a temperature of 20° Celsius, the relationship between the flow rate and the diameter of the flow path results in a flow in the mixing region, in the directing region, at the first inlet, at the second inlet and/or at the outlet which is characterized by a calculated Reynolds number (Re) of greater than or equal to one of the following values: 500, 1000, 1100, 1200, 1300, 1400, 1500, 1700, 1800, 1900, 2000.

Item 25: The fluid handling system of any one of the preceding items, wherein the fluid handling system is configured to be operated with a flow rate and/or to have a diameter (e.g. a minimum, maximum or average diameter) of the flow path such that, for water having a density of 1 g/cm³, a viscosity of 1 cP and a temperature of 20° Celsius, the relationship between the flow rate and the diameter of the flow path results in a flow in the mixing region, in the directing region, at the first inlet, at the second inlet and/or at the outlet which is characterized by a calculated Reynolds number (Re) of less than or equal to one of the following values: 10000, 7500, 5000, 4000, 3000, 2900, 2800, 2700, 2600, 2500.

Item 26: The fluid handling system of item 24 or item 25, wherein the fluid handling system is capable of handling or providing a fluid flow, the fluid flow, e.g. in the mixing region, in the directing region, at the first inlet, at the second inlet and/or at the outlet, having a Reynolds number (Re) of between 500 and 10000, e.g. between 500 and 3000, such as between 1700 and 2500.

Item 27: The fluid handling system of any one of the preceding items, wherein the first fluid substance and the second fluid substance are chosen such that the fluid substance mixture resulting from mixing the first fluid substance and the second fluid substance has an intermediate state, e.g. during and/or directly after mixing of the first fluid substance and the second fluid substance.

Item 28: The fluid handling system of item 27, wherein the intermediate state is a temporary state, e.g. a state existing only for less than the predetermined period of time.

Item 29: The fluid handling system of item 27 or 28, wherein the fluid substance mixture, after the intermediate state, assumes a stable state.

Item 30: The fluid handling system of any one of items 27 to 29, wherein, the fluid substance mixture, in its intermediate state, has a greater tendency to form a deposit on a wall, e.g. an inner wall delimiting a fluid path, than in the stable state.

Item 31: The fluid handling system of any one of items 27 to 30, wherein the fluid handling system is configured such that the fluid substance mixture, in its intermediate state, flows in the unguided flow region.

Item 32: The fluid handling system of any one of items 27 to 31, wherein the fluid handling system is configured and/or operable such that the fluid substance mixture, in its intermediate state, only flows in the mixing region and/or the unguided flow region and/or, optionally, the directing region.

Item 33: The fluid handling system of any one of the preceding items, wherein the first fluid substance and the second fluid substance are chosen so as to establish a fluid substance mixture comprising colloids, e.g. with an average particle size of the colloids of greater than or equal to 10 nm and/or less than or equal to 1000 nm.

Item 34: The fluid handling system of any one of the preceding items, wherein the first fluid substance comprises an ionic and/or an ionizable substance.

Item 35: The fluid handling system of any one of the preceding items, wherein the second fluid substance comprises an ionic and/or an ionizable substance.

Item 36: The fluid handling system of item 34 or 35, wherein the ionic and/or ionizable substance is a cationic or an anionic substance or a cationic and anionic substance, e.g. a zwitterionic substance and/or a cationic or an anionic ionizable substance or a cationic and anionic ionizable substance, e.g. a zwitterionic ionizable substance.

Item 37: The fluid handling system of any one of the preceding items 34 to 36, wherein the ionic substance of the first fluid substance is an anionic substance and the ionic substance of the second fluid substance is a cationic substance.

Item 38: The fluid handling system of any one of the preceding items 34 to 37, wherein the first fluid substance comprises a substance of polymeric nature, e.g. an ionic substance of polymeric nature.

Item 39: The fluid handling system of any one of the preceding items 34 to 38, wherein the first fluid substance comprises a nucleic acid, a peptide or a protein.

Item 40: The fluid handling system of any one of the preceding items 34 to 39, wherein the first fluid substance comprises RNA, wherein, optionally, the first fluid substance is an RNA, such as mRNA, solution.

Item 41: The fluid handling system of any one of the preceding items, wherein the second fluid substance is a colloidal suspension, e.g. an ionic colloidal suspension, such as a cationic colloidal suspension.

Item 42: The fluid handling system of any one of the preceding items, wherein the second fluid substance comprises a hydrophilic and/or lipophilic substance, e.g. an amphiphilic substance.

Item 43: The fluid handling system of any one of the preceding items, wherein the second fluid substance comprises at least one lipid.

Item 44: The fluid handling system of any one of the preceding items, wherein the second fluid substance comprises liposomes.

Item 45: The fluid handling system of any one of the preceding items, wherein the second fluid substance comprises a cationic polymer.

Item 46: The fluid handling system of any one of one of the items 1 to 45, wherein the first fluid substance and the second fluid substance both are colloidal suspensions, e.g. ionic colloidal suspensions.

Item 47: The fluid handling system of any one of the preceding items, wherein the first fluid substance is or comprises a polymeric amphiphilic substance or a polymeric lipophilic substance or a polymeric hydrophilic substance and wherein the second fluid substance comprises an amphiphilic or a polymeric amphiphilic substance or a polymeric lipophilic substance or a polymeric hydrophilic substance.

Item 48: The fluid handling system of any one of the preceding items, wherein the first fluid substance and/or the second fluid substance is buffered.

Item 49: The fluid handling system of any one of the preceding items, wherein one of the first fluid substance and second fluid substance or the fluid substance mixture is a biopharmaceutical substance.

Item 50: The fluid handling system of any one of the preceding items, wherein at least one of or both of the first fluid substance and the second fluid substance is an aqueous composition, e.g. an aqueous solution or an aqueous dispersion, or both of the first fluid substance and the second fluid substance are aqueous compositions, e.g. aqueous solutions or aqueous dispersions.

Item 51: The fluid handling system of any one of the preceding items, wherein at least one of or both of the first fluid substance and the second fluid substance is a solution.

Item 52: The fluid handling system of any one of the preceding items, wherein at least one of or both of the first fluid substance and the second fluid substance is a dispersion.

Item 53: The fluid handling system of any one of the preceding items, wherein the first fluid substance is an aqueous composition, e.g. an aqueous solution or an aqueous dispersion, and the second fluid substance is an organic composition.

Item 54: The fluid handling system of item 53, wherein the organic composition is an organic solution or dispersion.

Item 55: The fluid handling system of any one of the preceding items, wherein one of or both of the first fluid substance and the second fluid substance are medical fluid substances.

Item 56: The fluid handling system of any one of the preceding items, wherein the fluid substance mixture is a colloidal suspension comprising particles, the particles, e.g. nanoparticles, being formed from one or more constituents of the first fluid substance and from one or more constituents of the second fluid substance wherein, optionally, the nanoparticle is a nanoparticle composition, e.g. polymer nanoparticles, or particles comprising a lipid and a polymer, e.g. lipid or liposome nanoparticles (LNP), lipoplexes (LPX), polyplexes (PPX). are lipoplexes (LPX).

Item 57: The fluid handling system of any one of the preceding items, wherein the first fluid path is fluidly connected to or fluidly connectable to a first reservoir comprising the first fluid substance such that the first fluid substance can be driven from the first reservoir towards the mixing region through the first fluid path, and/or wherein the second fluid path is fluidly connected to or fluidly connectable to a second reservoir comprising the second fluid substance such that the second fluid substance can be driven from the second reservoir towards the mixing region through the second fluid path.

Item 58: The fluid handling system of any one of the preceding items, wherein the fluid path system is a closed and/or uninterrupted system.

Item 59: The fluid handling system of any one of the preceding items, wherein the fluid handling system comprises a reservoir region for collecting the fluid substance mixture, the reservoir region being arranged downstream of the unguided flow region as seen along the flow direction of the fluid substance mixture in the fluid handling system.

Item 60: The fluid handling system of item 59, wherein the fluid substance mixture in the reservoir region forms a surface, which delimits the reservoir region, e.g. on the side facing towards the unguided flow region as seen in the direction opposite to the flow direction of the fluid substance mixture towards the reservoir region.

Item 61: The fluid handling system of item 60, wherein the fluid handling system is configured such that the fluid substance mixture, after having travelled through the unguided flow region, enters the reservoir region via the surface, e.g. in the form of a fluid jet or fluid drops impinging on the surface.

Item 62: The fluid handling system of any one of the preceding items 59 to 61, wherein the fluid handling system comprises a reservoir region outlet which is in fluid communication with the reservoir region and which is provided to remove content, e.g. the fluid substance mixture, from the reservoir region.

Item 63: The fluid handling system of any one of the preceding items 59 to 62, wherein the fluid substance mixture in the reservoir region contacts an inner wall delimiting the fluid handling system laterally.

Item 64: The fluid handling system of any one of the preceding items 59 to 63, wherein the fluid path system comprises the reservoir region.

Item 65: The fluid handling system of any one of the preceding items 59 to 64, wherein the reservoir region is arranged within a container.

Item 66: The fluid handling system of any one of the preceding items 59 to 65, wherein the reservoir region or the container has a volume greater than the mixing region.

Item 67: The fluid handling system of any one of the preceding items 59 to 66, wherein the reservoir region or the container has a volume smaller than the mixing region.

Item 68: The fluid handling system of any one of the preceding items 66 to 67, wherein the container has a filling capacity of greater than or equal to: 0.5 L, 1 L, 2 L, 3 L, 4 L, 5 L, 6 L, 7 L, 8 L, 9 L, 10 L, 15 L, 20 L, 25 L, 30 L, 35 L, 40 L, 45 L, 50 L, 100 L, 200 L, 300 L, 400 L, 500 L, 600 L, 700 L, 800 L, 900 L, 1000 L.

Item 69: The fluid handling system of any one of the preceding items 66 to 68, wherein the container has a filling capacity of less than or equal to: 1000 L, 900 L, 800 L, 700 L, 600 L, 500 L, 400 L, 300 L, 200 L, 150 L, 100 L, 50 L, 45 L, 40 L, 35 L, 30 L, 25 L, 20 L, 15 L, 10 L, 5 L.

Item 70: The fluid handling system of any one of the preceding items 65 to 69, wherein the container, e.g. a bag, is collapsible and/or has flexible walls delimiting its interior or the container, e.g. a flask, is non-collapsible and/or has rigid walls delimiting its interior.

Item 71: The fluid handling system of any one of the preceding items 65 to 70, wherein at least a portion of the unguided flow region or the entire unguided flow region is within the container.

Item 72: The fluid handling system of any one of the preceding items 65 to 71, wherein the fluid handling system, e.g. the container, comprises a port for adding a further substance to the fluid substance mixture, e.g. downstream of the unguided flow region and/or in the container.

Item 73: The fluid handling system of any one of the preceding items, wherein the fluid handling system is configured such that the fluid substance mixture, downstream of the unguided flow region, is guided away from the unguided flow region towards an exit of the fluid handling system or fluid path system e.g. to enable a continuous withdrawal of fluid substance mixture from the fluid handling system via the exit.

Item 74: The fluid handling system of any one of the preceding items, wherein the fluid path system, in the unguided flow region, comprises an increased diameter of a mixture fluid path of the fluid path system such that an unguided flow of the fluid substance mixture is possible in the unguided flow region.

Item 75: The fluid handling system of item 74, wherein the diameter of the mixture fluid path varies in the unguided flow region.

Item 76: The fluid handling system of item 74 or 75, wherein a diameter of the mixture fluid path increases in a direction away from the mixing region in the unguided flow region, e.g. at least in a section of the mixture fluid path and/or continuously.

Item 77: The fluid handling system of any one of the preceding items 74 to 76, wherein a diameter of the mixture fluid path decreases in a direction away from the mixing region in the unguided flow region, e.g. at least in a section of the mixture fluid path and/or continuously.

Item 78: The fluid handling system of any one of the preceding items, wherein the fluid handling system comprises an agitator to agitate fluid substance.

Item 79: The fluid handling system of item 78, wherein the agitator is arranged to agitate the fluid substance mixture, e.g. in the reservoir region.

Item 80: The fluid handling system of item 78 or 79, wherein the agitator is arranged in the content to be agitated.

Item 81: The fluid handling system of any one of the preceding items 78 to 80, wherein the agitator is a magnetic agitator, e.g. a magnetic stirring bar.

Item 82: The fluid handling system of any one of the preceding items, wherein the mixing region has a first inlet for the first fluid substance and a second inlet for the second fluid substance.

Item 83: The fluid handling system of any one of the preceding items, wherein the mixing region is formed by a mixing component, which is connected to a first tubing defining the first fluid path and/or a second tubing defining the second fluid path.

Item 84: The fluid handling system of item 74, wherein the mixing component has an outlet directed towards the unguided flow region, optionally directed towards the directing region or being part of the directing region.

Item 85: The fluid handling system of item 83 or 84, wherein the mixing component is a T-shaped component, a Y-shaped component, a X-shaped component or a component with a psi-geometry.

Item 86: The fluid handling system of any one of the preceding items, wherein the mixing region is provided by a section of a continuous tubing structure, the tubing structure having further sections providing the first fluid path and the second fluid path, the first and second fluid paths being fluidically separated from one another up to the mixing region.

Item 87: The fluid handling system of any one of the preceding items, wherein a tubing structure for the first fluid path, the second fluid path and/or the mixing region is made of or comprises plastic, e.g. medical grade plastic and/or polypropylene or polyvinylidene fluoride (PVDF), or non-plastic materials e.g. medical grade materials such as stainless steel.

Item 88: The fluid handling system of any one of the preceding items wherein the fluid handling system is configured so as to provide a turbulent mixing of the first fluid substance and the second fluid substance in the mixing region.

Item 89: A method for processing fluids, comprising:
guiding a first fluid substance and a second fluid substance within a fluid path system to a mixing region to form a fluid substance mixture, and
preventing contact between the fluid substance mixture and a wall of the fluid path system for a predetermined period of time, in an unguided flow region along the flow direction of the fluid substance mixture downstream of the mixing region.

Item 90: The method for processing fluids according to item 89, wherein the predetermined period of time is less than or equal to one of the following: 1 s, 950 ms, 900 ms, 850 ms, 800 ms, 750 ms, 700 ms, 650 ms, 600 ms, 550 ms, 500 ms, 450 ms, 400 ms.

Item 91: The method for processing fluids according to item 89 or 90, wherein the predetermined period of time is greater than or equal to one of the following: 1 ms, 5 ms, 10 ms, 20 ms, 25 ms, 50 ms, 100 ms, 150 ms, 200 ms, 300 ms.

Item 92: The method for processing fluids according to any one of the items 89 to 91, wherein the first fluid substance and the second fluid substance are chosen such that the fluid substance mixture resulting from mixing the first fluid substance and the second fluid substance has an intermediate state, e.g. during and/or directly after mixing of the first fluid substance and the second fluid substance.

Item 93: The method for processing fluids according to item 92, wherein the intermediate state is a temporary state, e.g. a state existing only for less than the predetermined period of time.

Item 94: The method for processing fluids according to any one of the items 89 to 93, wherein the first fluid substance and the second fluid substance are guided through the mixing region for a time period of at least greater than or equal to 10 ms and less than or equal to 80 ms, e.g. greater than or equal to 20 ms and less than or equal to 60 ms, to form a fluid substance mixture.

Item 95: The method for processing fluid according to any one of the items 89 to 94, wherein guiding the first fluid substance to a mixing region comprises guiding the first fluid substance through a first fluid path of the fluid path system and/or guiding the second fluid substance to a mixing region comprises guiding the second fluid substance through a second fluid path of the fluid path system.

Item 96: The method for processing fluids according to any one of the items 89 to 95, further comprising:
guiding the fluid substance mixture through a directing region positioned downstream of the mixing region, to direct the fluid substance mixture towards the unguided flow region.

Item 97: The method for processing fluids according to any one of items 89 to 95, further comprising:
guiding the fluid substance mixture within a fluid guiding element of the fluid path system positioned downstream of the unguided flow region and/or
receiving the fluid substance mixture in a fluid retaining element of the fluid path system positioned downstream of the unguided flow region.

Item 98: The method for processing fluids according to any one of items 89 to 97, further comprising: guiding the first fluid and the second fluid simultaneously into the mixing region.

Item 99: The method for processing fluids according to any one of items 89 to 98, further comprising driving the fluid flow of the first fluid substance with a first flow driver, e.g. a pump, such as a syringe pump, a peristaltic pump, a pressurized vessel, a diaphragm pump and/or a piston pump.

Item 100: The method for processing fluids according to any one of items 89 to 99, further comprising: driving the fluid flow of the second fluid substance with a second flow driver, e.g. a pump, such as a syringe pump, a peristaltic pump, a pressurized vessel, a diaphragm pump and/or a piston pump.

Item 101: The method for processing fluids according to any one of items 89 to 100, further comprising: driving the flow of the fluid substance mixture downstream of the unguided flow region with a mixture flow driver, e.g. a pump, such as a syringe pump, a peristaltic pump, a diaphragm pump and/or a piston pump, or a pressurized vessel.

Item 102: The method for processing fluids according to any one of items 89 to 101, further comprising: moving the fluid substance mixture through a free fall or a free flow region, the free fall or free flow region being the unguided flow region.

Item 103: The method for processing fluids according to any one of items 89 to 102, wherein the fluid handling system is configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region, in the directing region, at a first inlet of the first fluid path, at a second inlet of the second fluid path and/or at an outlet of the mixing region which is characterized by a calculated Reynolds number (Re) of less than or equal to one of the following values: 10000, 7500, 5000, 4000, 3000, 2900, 2800, 2700, 2600, 2500.

Item 104: The method for processing fluids according to any one of items 89 to 103, wherein the fluid handling system is configured to be operated with a flow rate and/or to have a diameter of the flow path such that, for water having a density of 1 g/cm³, a viscosity of 1 cP and a temperature of 20° Celsius, the relationship between the flow rate and the diameter of the flow path results in a flow in the mixing region, in the directing region, at a first inlet of the first fluid path, at a second inlet of the second fluid path and/or at an outlet of the mixing region which is characterized by a calculated Reynolds number (Re) of greater than or equal to one of the following values: 500, 1000, 1100, 1200, 1300, 1400, 1500, 1700, 1800, 1900, 2000.

Item 105: The method for processing fluids according to any one of items 89 to 104, wherein the method is performed with the fluid handling system of any one of items 1 to 88.

Item 106: Use of the fluid handling system according to any one of the items 1 to 88 for mixing a first fluid substance with a second fluid substance to provide a fluid substance mixture.

Item 107: Fluid substance mixture obtainable or obtained by the method of processing fluids according to any one of the items 89 to 106.

### REFERENCE NUMERALS

20 tubing prior art
100 Fluid handling system
202 first fluid path
204 second fluid path
206 first flow driver
208 second flow driver
300 mixing region
302 mixing region (first) inlet
304 mixing region (second) inlet
304a, 304b second inlets
306 mixing component
400 unguided flow region
402 wall unguided flow region
404 wall unguided flow region
406 fluid guiding element
408a, 408b widening of the fluid path
410 entry region
500 directing region
600 free fall region
602 first reservoir
604 second reservoir
700 reservoir region
702 surface
704 droplets of fluid substance mixture
706 outlet
708 mixture flow driver
DP1 deposit
DP2 deposit
AR1 flow direction fluid substance mixture
AR2 fluid flow of first fluid substance
AR3 fluid flow of second fluid substance
AR4 entry flow direction
AR6 entry flow direction
AR7 main axis unguided flow region
F1 first fluid substance
F2 second fluid substance
MX fluid substance mixture
S1 first method step
S2 second method step

1. A fluid handling system, comprising:
a fluid path system, the fluid path system comprising
a first fluid path for guiding a first fluid substance towards a mixing region of the fluid path system,
a second fluid path for guiding a second fluid substance towards the mixing region, wherein
the mixing region is arranged to be in fluid communication with the first fluid path and the second fluid path such that the first fluid substance and the second fluid substance can be mixed in the mixing region to form a fluid substance mixture, wherein
the fluid handling system comprises an unguided flow region, wherein the unguided flow region is configured such that the fluid substance mixture can be or is prevented from contacting an inner wall suitable for guiding a flow of the fluid substance mixture along a flow direction of the fluid substance mixture while the fluid substance mixture travels through the unguided flow region, and wherein the unguided flow region extends for a predetermined distance, e.g. extends only for the predetermined distance, downstream of the mixing region.

2. The fluid handling system of claim 1, wherein a fluid guiding element or fluid retaining element of the fluid handling system is positioned downstream of the unguided flow region to receive and/or guide the fluid substance mixture.

3. The fluid handling system of any one of the preceding claims, wherein the fluid handling system is configured such that the first fluid substance and the second fluid substance can be moved into the mixing region simultaneously.

4. The fluid handling system of any one of the preceding claims, wherein the fluid path system comprises a directing region arranged between the mixing region and the unguided flow region as seen along the flow direction of the fluid substance mixture, wherein the directing region is configured to determine an entry flow direction of the fluid substance mixture with which the fluid substance mixture enters the unguided flow region.

5. The fluid handling system of any one of the preceding claims, wherein, for the predetermined distance, the fluid handling system, e.g. due to an interruption of the fluid path system in the unguided flow region and/or due to a mixture fluid path of the fluid path system being configured with an appropriate width in the unguided flow region, has a free fall region or free flow region which allows the fluid substance mixture to travel within the fluid handling system without contacting the inner wall of the fluid handling system, e.g. the inner wall which is closest to the fluid substance mixture.

6. The fluid handling system of any one of the preceding claims, wherein the predetermined distance is chosen such that the fluid substance mixture can be or is prevented from contacting the inner wall for a predetermined period of time, e.g. during operation of the fluid handling system.

7. The fluid handling system of claim 6, wherein the predetermined period of time is less than or equal to one of the following: 1 s, 950 ms, 900 ms, 850 ms, 800 ms, 750 ms, 700 ms, 650 ms, 600 ms, 550 ms, 500 ms, 450 ms, 400 ms, and/or wherein the predetermined period of time is greater than or equal to one of the following: 1 ms, 5 ms, 10 ms, 20 ms, 25 ms, 50 ms, 100 ms, 150 ms, 200 ms, 300 ms.

8. The fluid handling system of any one of the preceding claims, wherein the first fluid substance and the second fluid substance are chosen such that the fluid substance mixture resulting from mixing the first fluid substance and the second fluid substance has an intermediate state, e.g. during and/or directly after mixing of the first fluid substance and the second fluid substance.

9. The fluid handling system of claim 8, wherein the intermediate state is a temporary state, e.g. a state existing only for less than the predetermined period of time.

10. The fluid handling system of any one of claims 8 to 9, wherein, the fluid substance mixture, in its intermediate state, has a greater tendency to form a deposit on a wall, e.g. an inner wall delimiting a fluid path, than in the stable state.

11. The fluid handling system of any one of claims 8 to 10, wherein the fluid handling system is configured such that the fluid substance mixture, in its intermediate state, flows in the unguided flow region.

12. The fluid handling system of any one of claims 8 to 11, wherein the fluid handling system is configured and/or operable such that the fluid substance mixture, in its intermediate state, only flows in the mixing region and/or the unguided flow region and/or, optionally, the directing region.

13. The fluid handling system of any one of the preceding claims, wherein the first fluid substance and the second fluid substance are chosen so as to establish a fluid substance mixture comprising colloids, e.g. with an average particle size of the colloids of greater than or equal to 10 nm and/or less than or equal to 1000 nm.

14. The fluid handling system of any one of the preceding claims, wherein the first fluid substance comprises a nucleic acid, a peptide or a protein.

15. The fluid handling system of any one of the preceding claims, wherein the second fluid substance is a colloidal suspension, e.g. an ionic colloidal suspension, such as a cationic colloidal suspension.

16. The fluid handling system of any one of the preceding claims, wherein the fluid handling system is configured such that the fluid substance mixture, downstream of the unguided flow region, is guided away from the unguided flow region towards an exit of the fluid handling system or fluid path system e.g. to enable a continuous withdrawal of fluid substance mixture from the fluid handling system via the exit.

17. The fluid handling system of any one of the preceding claims, wherein the fluid path system, in the unguided flow region, comprises an increased diameter of a mixture fluid path of the fluid path system such that an unguided flow of the fluid substance mixture is possible in the unguided flow region.

18. The fluid handling system of claim 17, wherein the diameter of the mixture fluid path varies in the unguided flow region.

19. The fluid handling system of claim 17 or 18, wherein a diameter of the mixture fluid path increases in a direction away from the mixing region in the unguided flow region, e.g. at least in a section of the mixture fluid path and/or continuously; or
wherein a diameter of the mixture fluid path decreases in a direction away from the mixing region in the unguided flow region, e.g. at least in a section of the mixture fluid path and/or continuously.

20. The fluid handling system of any one of the preceding claims, wherein the mixing region is formed by a mixing component, which is connected to a first tubing defining the first fluid path and/or a second tubing defining the second fluid path.

21. The fluid handling system of any one of the preceding claims wherein the fluid handling system is configured so as to provide a turbulent mixing of the first fluid substance and the second fluid substance in the mixing region.

22. A method for processing fluids, comprising:
guiding a first fluid substance and a second fluid substance within a fluid path system to a mixing region to form a fluid substance mixture, and
preventing contact between the fluid substance mixture and a wall of the fluid path system for a predetermined period of time, in an unguided flow region along the flow direction of the fluid substance mixture downstream of the mixing region.

23. The method for processing fluids according to claim 22, wherein the predetermined period of time is less than or equal to one of the following: 1 s, 950 ms, 900 ms, 850 ms, 800 ms, 750 ms, 700 ms, 650 ms, 600 ms, 550 ms, 500 ms, 450 ms, 400 ms and/or wherein the predetermined period of time is greater than or equal to one of the following: 1 ms, 5 ms, 10 ms, 20 ms, 25 ms, 50 ms, 100 ms, 150 ms, 200 ms, 300 ms.

24. The method for processing fluids according to any one of the claims 22 to 23, wherein the first fluid substance and the second fluid substance are chosen such that the fluid substance mixture resulting from mixing the first fluid substance and the second fluid substance has an intermediate state, e.g. during and/or directly after mixing of the first fluid substance and the second fluid substance.

25. The method for processing fluids according to claim 24, wherein the intermediate state is a temporary state, e.g. a state existing only for less than the predetermined period of time.

26. The method for processing fluids according to any one of the claims 22 to 25, wherein the first fluid substance and the second fluid substance are guided through the mixing region for a time period of at least greater than or equal to 10 ms and less than or equal to 80 ms, e.g. greater than or equal to 20 ms and less than or equal to 60 ms, to form a fluid substance mixture.

27. The method for processing fluids according to any one of the claims 22 to 26, further comprising: guiding the fluid substance mixture through a directing region positioned downstream of the mixing region, to direct the fluid substance mixture towards the unguided flow region.

28. The method for processing fluids according to any one of claims 22 to 27, further comprising: guiding the first fluid and the second fluid simultaneously into the mixing region.

29. The method for processing fluids according to any one of claims 22 to 28, further comprising: moving the fluid substance mixture through a free fall or a free flow region, the free fall or free flow region being the unguided flow region.

30. The method for processing fluids according to any one of claims 22 to 29, wherein the method is performed with the fluid handling system of any one of claims 1 to 21.

31. Use of the fluid handling system according to any one of the claims 1 to 21 for mixing a first fluid substance with a second fluid substance to provide a fluid substance mixture.

32. Fluid substance mixture obtainable or obtained by the method of processing fluids according to any one of the claims 22 to 30.
